(19) United States
(12) Patent Application Publication
(10) Pub. No.: US 2004/0098348 A1
(43) Pub. Date: May 20, 2004

(54) License issuance server, processing device, software execution management device, and license issuing method and program

(75) Inventors: Takashi Kawasaki, Kawasaki (JP); Koichi Sasamori, Kawasaki (JP); Masayuki Shinagawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/662,996

(22) Filed: Sep. 15, 2003

(30) Foreign Application Priority Data
Sep. 20, 2002 (JP) 2002-274845

(51) Int. Cl. G06F 17/60

(52) U.S. Cl. 705/59

(57) ABSTRACT

A license issuance server capable of performing a function of securely preventing illegalities concerning the granting of licenses to individual machines. In response to an encryption key generation request for software, software encryption key generating means generates a software encryption key and a software decryption key for decrypting the software encrypted by using the software encryption key. In response to a license issue request including device identification information fixedly recorded on a recording medium in a processing device which is a target of permission to run the software, license issuing means encrypts the software decryption key by using the device identification information and outputs a software license including the encrypted software decryption key. Thus, the encrypted software can be decrypted only in the processing device in which the device identification information is fixedly recorded.

### BACKGROUND OF THE INVENTION

(1) Field of the Invention

The present invention relates to a license issuance server, processing device, software execution management device, and license issuing method and program for restricting the execution of software according to license, and more particularly, to a license issuance server, processing device, software execution management device, and license issuing method and program capable of preventing illegal acquisition of license.

(2) Description of the Related Art

Generally, when software is sold, the purchaser is granted a license to use the software. Such a license imposes restrictions on the number of computers that can be used simultaneously, the term of use, the number of users allowed to use the software simultaneously in the case of a multi-user system, etc.

In recent years, however, illegal use of software beyond the restrictions imposed by license has become an object of public concern. For example, most software on the market permits only one computer to run the software, in a clause of the license. However, if the software has no illegal use prevention function incorporated therein, the software can readily be used on numerous computers.

Various techniques have therefore been developed to prevent illegal use of software. Some of such techniques use computer-specific identification information.

For example, a software management method is known in which use of software is checked by means of a machine-specific software use code generated from a license code and a machine identification code (see Japanese Unexamined Patent Publication No. 2002-207199, for example). This patent document discloses that the machine identification code may include the name of an OS (Operating System) on which the software runs, the OS number, and the number assigned to a hard disk on which the software is installed.

According to the invention described in Japanese Unexamined Patent Publication No. 2002-207199, however, if the OS name or the OS number is used as the machine identification code and if the OS of the machine to which license has been granted is illegally copied, then the software can be run also on the copy of the OS. The hard disk number is a number that the OS defines for each computer. Thus, even in the case where the hard disk number is included in the machine identification code, illegally copied software can be run if the software is installed on a hard disk with a hard disk number identical with the original one.

In this manner, with the software management method disclosed in Unexamined Japanese Patent Publication No. 2002-207199, information included in the machine identification code can be easily copied, making it easy to illegally use software beyond the restrictions imposed by license.

### SUMMARY OF THE INVENTION

The present invention was created in view of the above circumstances, and an object thereof is to provide a license issuance server, processing device, software execution management device, and license issuing method and program which can perform a function of securely preventing illegalities concerning the granting of licenses to individual machines.

To achieve the object, there is provided a license issuance server for issuing a license for execution of software. The license issuance server comprises software encryption key generating means, responsive to an encryption key generation request for the software, for generating a software encryption key and a software decryption key for decrypting the software encrypted using the software encryption key, and license issuing means, responsive to a license issue request including device identification information fixedly recorded on a recording medium in a processing device which is a target of permission to run the software, for encrypting the software decryption key by using the device identification information as an encryption key and outputting a software license including the encrypted software decryption key.

Also, to achieve the above object, there is provided a processing device for executing software whose execution is restricted by a license. The processing device comprises a recording medium on which device identification information is fixedly recorded, decryption key decrypting means, responsive to reception of a software decryption key which has been encrypted, for decrypting the software decryption key by using the device identification information recorded on the recording medium as a decryption key, and software decrypting means, responsive to reception of the software which has been encrypted, for decrypting the software by using the software decryption key decrypted by the decryption key decrypting means as a decryption key.

Further, to achieve the above object, there is provided a software execution management device for managing status of execution of software whose execution is restricted by a license. The software execution management device comprises a recording medium on which device identification information is fixedly recorded, hardware key connecting means for reading attach/detach key information including an attach/detach key-specific encryption key and permission target device identification information specifying a device which is a target of permission to run the software, from a hardware key storing the attach/detach key information when the hardware key is attached, software key decrypting means, responsive to input of license information including an encrypted software decryption key for decrypting the software which has been encrypted and a number of computers permitted to execute the software simultaneously, for decrypting the software decryption key by using the attach/detach key-specific encryption key, and decryption key managing means for monitoring computers connected via a network to detect a number of computers executing the software, and transferring the software decryption key decrypted by the software key decrypting means to a number of computers equal to or smaller than the number of computers permitted to execute the software simultaneously.

To achieve the above object, there is also provided a license issuing method for issuing a license for execution of software. The license issuing method comprises the step of generating, in response to an attach/detach key information generation request including device identification information fixedly recorded on a recording medium in a processing device which is a target of permission to run the software, attach/detach key information including the device identification information and an attach/detach key-specific encryption key, and recording the generated attach/detach key information on a hardware key which can be attached to and detached from the processing device, and the step of encrypting, in response to a license issue request for the software, a software decryption key for decrypting the software provided in an encrypted state, by using the attach/detach key-specific encryption key, and outputting license information including the encrypted software decryption key.

To achieve the above object, there is further provided a license issuing program for issuing a license for execution of software. The license issuing program causes a computer to perform the process of generating, in response to an encryption key generation request for the software, a software encryption key and a software decryption key for decrypting the software encrypted using the software encryption key, and the process of encrypting, in response to a license issue request including device identification information fixedly recorded on a recording medium in a processing device which is a target of permission to run the software, the software decryption key by using, as an encryption key, the device identification information, and outputting a software license including the encrypted software decryption key.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual diagram of invention applied to a first embodiment;

FIG. 2 is a diagram showing an exemplary system configuration of the first embodiment;

FIG. 3 is a diagram showing an exemplary hardware configuration of a software provision server used in the embodiment of the present invention;

FIG. 4 is a functional block diagram of a software license management system according to the first embodiment;

FIG. 5 is a sequence diagram showing a software encryption process according to the first embodiment;

FIG. 6 is a sequence diagram showing a software provision process according to the first embodiment;

FIG. 7 is a conceptual diagram of invention applied to a second embodiment;

FIG. 8 is a conceptual diagram of a license management system according to the second embodiment;

FIG. 9 is a conceptual diagram of a license management mechanism according to the second embodiment;

FIG. 10 is a diagram showing an exemplary hardware configuration of a processing device;

FIG. 11 is a diagram showing an exemplary hardware configuration of a processor cartridge;

FIG. 12 is a block diagram showing processing functions of respective server computers;

FIG. 13 is a diagram showing an exemplary data structure of attach/detach key information stored in an attach/detach key;

FIG. 14 is a diagram showing an exemplary data structure of an attach/detach key issue recording database;

FIG. 15 is a diagram showing an exemplary data structure of an application registration recording database;

FIG. 16 is a diagram showing an exemplary data structure of an application execution license;

FIG. 17 is a diagram showing an exemplary data structure of a license information database;

FIG. 18 is a diagram showing an exemplary data structure of a license issue recording database;

FIG. 19 is a conceptual diagram illustrating a hardware key generation process;

FIG. 20 is a flowchart showing a process of an attach/detach key information issuing section;

FIG. 21 is a conceptual diagram illustrating an application provision process;

FIG. 22 is a flowchart showing a process of an application encryption/decryption key issuing section;

FIG. 23 is a diagram showing states of an application before and after encryption;

FIG. 24 is a flowchart showing an application encryption process;

FIG. 25 is a conceptual diagram illustrating a license provision process;

FIG. 26 is a flowchart showing a process of a license issuing section;

FIG. 27 is a flowchart showing a license issue charge billing process;

FIG. 28 is a block diagram showing processing functions configured in processing devices;

FIG. 29 is a diagram showing an exemplary data structure of acquired license information;

FIG. 30 is a diagram showing an exemplary data structure of application running information;

FIG. 31 is a flowchart showing an application starting process;

FIG. 32 is a flowchart showing an application program decryption process;

FIG. 33 is a flowchart showing a process performed at the termination of an application;

FIG. 34 is a flowchart showing a continued application execution monitoring process;

FIG. 35 is a first flowchart showing a process of a license manager;

FIG. 36 is a second flowchart showing the process of the license manager;

FIG. 37 is a third flowchart showing the process of the license manager; and

FIG. 38 is a fourth flowchart showing the process of the license manager.

### DESCRIPTION OF THE PREFERRED EMBODIMENTS

Embodiments of the present invention will be hereinafter described with reference to the drawings.

[First Embodiment]

First, the invention applied to the embodiment will be outlined, and then the embodiment will be described in detail.

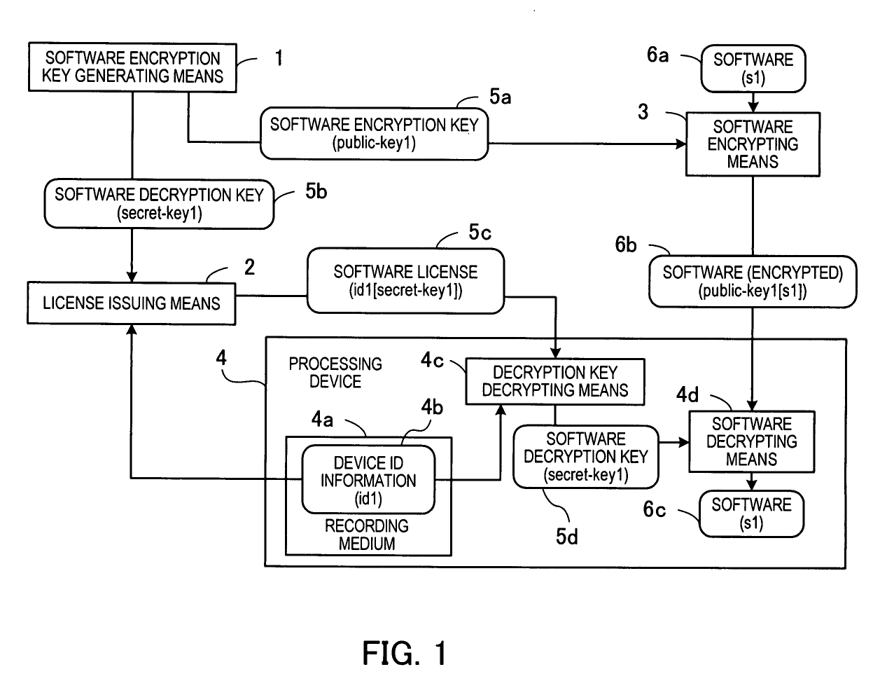

FIG. 1 illustrates the concept of the invention applied to the first embodiment. In the first embodiment, licensing of software 6a is managed by using device identification information 4b specific to hardware. Functions described below are prepared for this purpose.

In response to a request for generation of an encryption key for encrypting the software 6a, software encryption key generating means 1 generates a software encryption key 5a and a software decryption key 5b for decrypting the software 6b encrypted using the software encryption key 5a.

In response to a license issue request including the device identification information 4b fixedly recorded on a recording medium 4a in a processing device 4 which is a target of permission to run the software 6a, license issuing means 2 encrypts the software decryption key 5b by using the device identification information 4b, and outputs a software license 5c including the encrypted software decryption key 5a. The output software license 5c is transferred to the processing device 4.

Using the software encryption key 5a, software encrypting means 3 encrypts the software 6a. The encrypted software 6b is transferred to the processing device 4.

The processing device 4 is provided with the recording medium 4a, decryption key decrypting means 4c, and software decrypting means 4d. The recording medium 4a has the device identification information 4b fixedly recorded thereon. On receiving the software license 5c including the encrypted software decryption key, the decryption key decrypting means 4c decrypts the software decryption key 5d by using the device identification information 4b recorded on the recording medium 4a as a decryption key. After receiving the encrypted software 6b from a software provision server, the software decrypting means 4d decrypts the software 6b by using the software decryption key 5d decrypted by the decryption key decrypting means 4c as a decryption key. Consequently, the encrypted software is restored to a non-encrypted state 6c.

With the license issuance server described above, the software decryption key 5b is encrypted using the device identification information 4b, and accordingly, the encrypted software 6b can be decrypted only in the processing device 4 having the device identification information 4b fixedly recorded therein. Further, since the device identification information 4b is fixedly recorded on the recording medium 4a (e.g., a read-only semiconductor memory having a predetermined address space assigned thereto) of the processing device 4, it is difficult to copy or falsify the device identification information by software-based manipulation. As a result, illegal use of the software 6a can be prevented.

A system according to the first embodiment will be now described in detail.

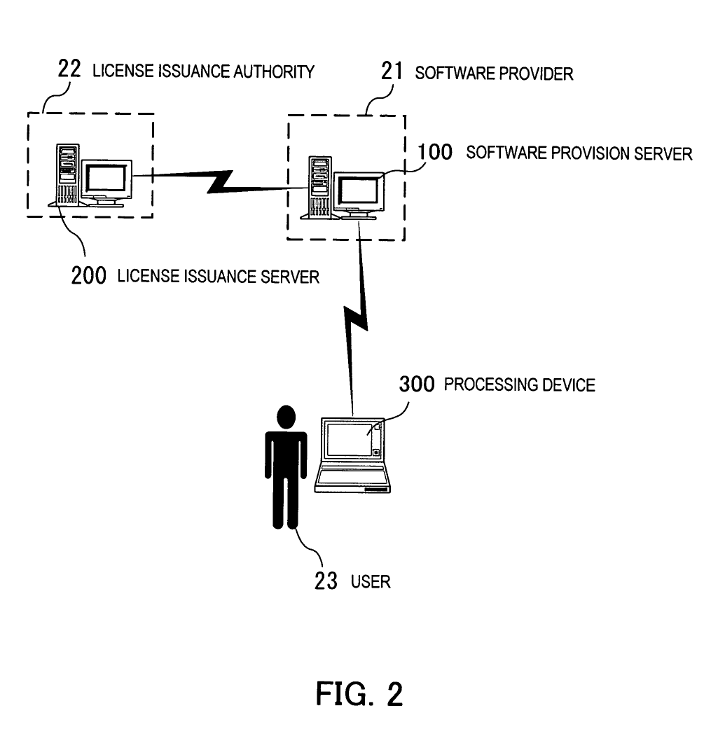

FIG. 2 shows an exemplary system configuration according to the first embodiment. In the first embodiment, a software provider 21 who develops or sells software, a license issuance authority 22 which is an agency taking charge of the issuance of license and a user 23 who uses the software put on sale are involved in the procedure relating to transaction of the software.

The software provider 21 owns a software provision server 100 for delivering software through a network etc.

The license issuance authority 22 owns a license issuance server 200 which is connected to the software provision server 100 through a network. In compliance with a request from the software provision server 100, the license issuance server 200 generates an encryption key for software to be transferred to each user or issues a software license key for each user. Specifically, the license issuance server 200 generates a software encryption key in compliance with an encryption key request from the software provision server 100, and generates a software license key in compliance with a software request from each user.

The software license key and encryption key generated in this manner are transferred to the software provision server 100 through the network or by means of information transfer media such as a portable recording medium (memory card etc.).

The user 23 owns a processing device 300 which is connected through the network to the software provision server 100. In response to an input operation by the user 23, the processing device 300 transmits a software request to the software provision server 100. After receiving encrypted software and an encrypted software license key from the software provision server 100, the processing device 300 executes the software within the limits as permitted by the software license key.

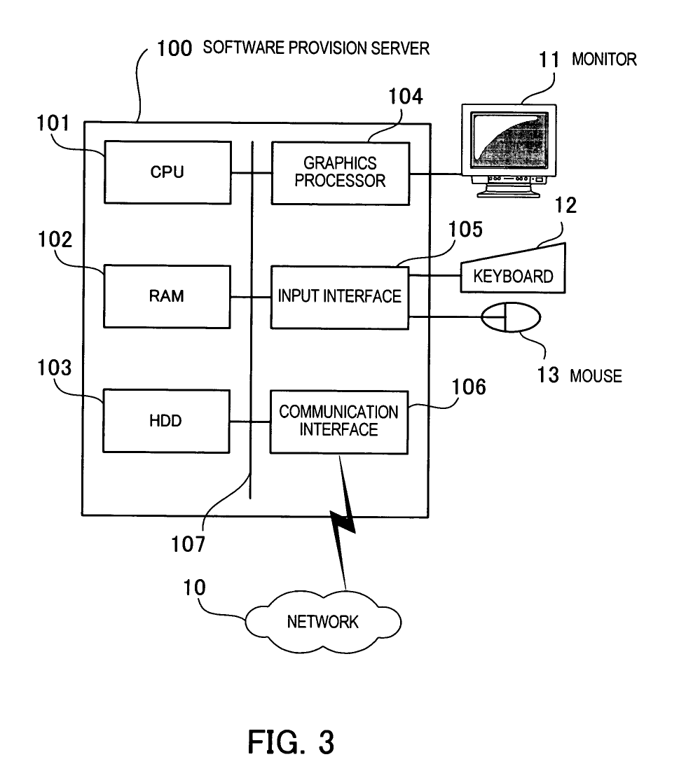

FIG. 3 shows an exemplary hardware configuration of the software provision server used in this embodiment of the present invention. The software provision server 100 is in its entirety under the control of a CPU (Central Processing Unit) 101. The CPU 101 is connected through a bus 107 with a RAM (Random Access Memory) 102, a hard disk drive (HDD) 103, a graphics processor 104, an input interface 105, and a communication interface 106.

The RAM 102 temporarily stores OS (Operating System) programs and at least part of an application program executed by the CPU 101. Also, the RAM 102 stores various other data necessary for the processing by the CPU 101. The HDD 103 stores the OS as well as application programs.

The graphics processor 104 is connected with a monitor 11. In accordance with instructions from the CPU 101, the graphics processor 104 causes the monitor 11 to display images on the screen thereof. The input interface 105 is connected with a keyboard 12 and a mouse 13. The input interface 105 sends signals input thereto from the keyboard 12 and the mouse 13 to the CPU 101 through the bus 107.

The communication interface 106 is connected to a network 10 and transmits and receives data to and from other computers through the network 10.

The processing functions of this embodiment can be implemented by the hardware configuration described above. Although FIG. 3 exemplifies the hardware configuration of the software provision server 100, the license issuance server 200 and the processing device 300 may also have a similar hardware configuration.

Processing functions of the individual devices according to the first embodiment will be now described.

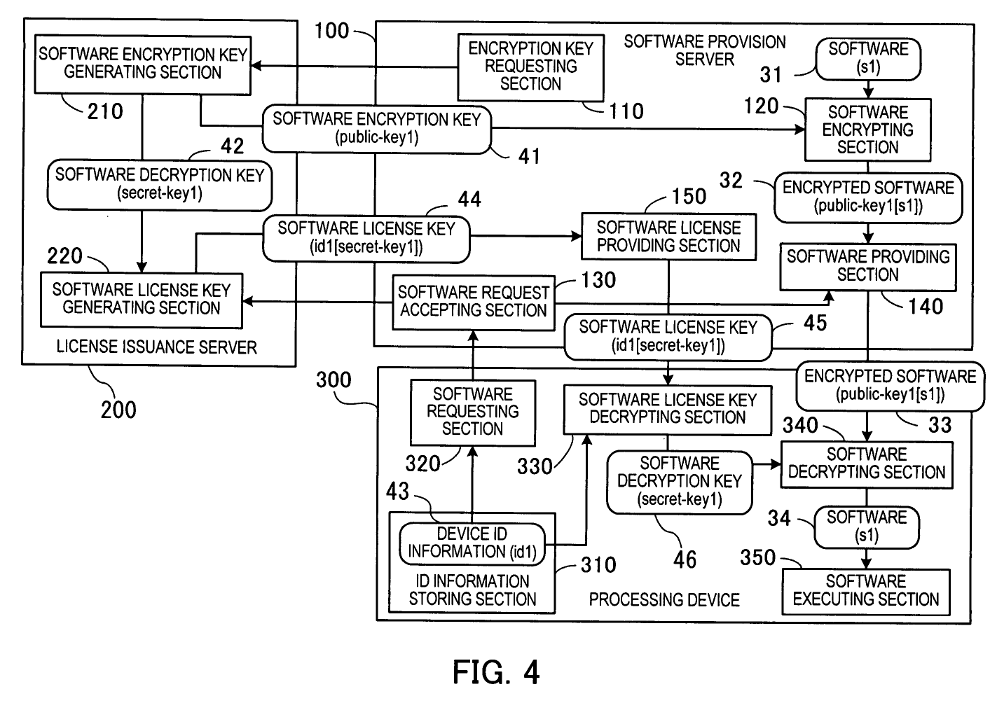

FIG. 4 is a functional block diagram of a software license management system according to the first embodiment, and illustrates respective processing functions of the software provision server 100, license issuance server 200 and processing device 300.

In FIG. 4, encrypted information is represented by the form “a[b]”, where “a” indicates a key (encryption key) used for the encryption and “b” indicates the encrypted data.

The software provision server 100 has an encryption key requesting section 110, a software encrypting section 120, a software request accepting section 130, a software providing section 140, and a software license providing section 150.

In response to an instruction to encrypt software (s1) 31, input by the software provider 21, the encryption key requesting section 110 outputs a software encryption key generation request to the license issuance server 200. The generation of a software encryption key may alternatively be requested to the license issuance authority 22 by mail or the like, instead of transmitting the request through the network. In this case, the operator at the license issuance authority 22 inputs the software encryption key generation request to the license issuance server 200. Further, the contents of the software encryption key generation request may be stored in a portable recording medium and the recording medium may be sent to the license issuance authority 22 by mail. In this case, the operator at the license issuance authority 22 inserts the recording medium in the license issuance server 200 and inputs the software encryption key generation request to the server 200.

The software encrypting section 120 receives a software encryption key (public-key1) 41 which the license issuance server 200 has sent in response to the software encryption key generation request. The software encryption key (public-key1) 41 is a public key. Then, using the received software encryption key (public-key1) 41, the software encrypting section 120 encrypts the software 31, thus obtaining encrypted software (public-keyl[s1]) 32. The encrypted software (public-keyl[s1]) 32 is stored in the HDD 103 or the like in the software provision server 100.

The software request accepting section 130 receives a software request from the processing device 300. After receiving the software request, the software request accepting section 130 first ascertains whether or not the user 23 has duly followed the procedure for purchasing the software 31. For example, user authentication is performed by having the user input a password or the like which is notified to each purchaser of the software 31.

After confirming that the user is an authentic purchaser, the software request accepting section 130 instructs the software providing section 140 to provide the software. Also, the software request accepting section 130 outputs a software license key request to the license issuance server 200.

On receiving the instruction to provide the software from the software request accepting section 130, the software providing section 140 makes a copy of the encrypted software (public-keyl[s1]) 32 stored in the software provision server 100 and transmits the copy, as encrypted software 33 for delivery, to the processing device 300 through the network. Alternatively, the encrypted software 33 may be sent to the user 23 by mail. In this case, the software providing section 140 stores the encrypted software 33 in a portable recording medium (e.g., memory card), and the operator of the software provider 21 sends the portable recording medium storing the encrypted software 33 to the user 23.

The software license providing section 150 receives a software license key (id1[secret-key1]) 44 which the license issuance server 200 has sent in response to the software license key request. Then, the software license providing section 150 transmits the software license key (id1[secret-key1]) 45 to the processing device 300 through the network. The software license key (id1[secret-key1]) 45 may alternatively be sent to the user 23 by mail or the like. In this case, the software license providing section 150 stores the software license key (id1[secret-key1]) 45 in a portable recording medium.

The license issuance server 200 has a software encryption key generating section 210 and a software license key generating section 220.

The software encryption key generating section 210 receives the software encryption key generation request sent from the encryption key requesting section 110 of the software provision server 100. Then, in compliance with the software encryption key generation request, the software encryption key generating section 210 generates a software encryption key (public-key1) 41 and a software decryption key (secret-key1) 42. Data encrypted using the software encryption key (public-key1) 41 as an encryption key can be restored only when the software decryption key (secret-key1) 42 is used as a decryption key. The software encryption key (public-key1) 41 is a public key, whereas the software decryption key (secret-key1) 42 is a secret key.

The software encryption key generating section 210 transmits the software encryption key (public-key1) 41 to the software provision server 100 through the network. The software encryption key (public-key1) 41 may alternatively be stored in a portable recording medium to be sent to the software provider 21 by mail or the like. The software encryption key generating section 210 also stores the software decryption key (secret-key1) 42 in the HDD or the like in the license issuance server 200.

The software license key generating section 220 receives the software license key request sent from the software request accepting section 130 of the software provision server 100. On receiving the software license key request, the software license key generating section 220 extracts device identification information (id1) 43 from the request, and encrypts the software decryption key (secretkey1) 42 by using the device identification information (id1) 43, thus obtaining a software license key (id1[secretkey1]) 44. Then, the software license key generating section 220 transmits the generated software license key (id1[secret-key1]) 44 to the software provision server 100 through the network. Alternatively, the software license key (id1[secret-key1]) 44 may be stored in a portable recording medium to be sent to the software provider 21 by mail or the like.

The processing device 300 has an identification information storing section 310, a software requesting section 320, a software license key decrypting section 330, a software decrypting section 340, and a software executing section 350.

The identification information storing section 310 comprises a recording medium (e.g., semiconductor memory such as ROM) built into the processing device 300, and the device identification information 43 by which the processing device 300 can be uniquely identified is recorded beforehand on the medium. The device identification information 43 is written by the manufacturer of the processing device and the contents thereof cannot be modified by the user 23.

In response to the user's input operation etc., the software requesting section 320 transmits a software request to the software provision server 100 through the network. When transmitting the software request, the software requesting section 320 acquires the device identification information 43 from the identification information storing section 310 and includes the acquired information 43 in the software request. In the case where the software request is sent to the software provider 21 by mail or the like, the software requesting section 320 stores the software request including the device identification information 43 in a portable recording medium.

The software license key decrypting section 330 receives the software license key (id1[secret-key1]) 45 transmitted thereto from the software provision server 100 via the network. In the case where the software license key (id1[secret-key1]) 45 is sent by mail, the portable recording medium in which the software license key (id1[secret-key1]) 45 is stored is inserted in the processing device 300 by the user 23. The software license key decrypting section 330 reads out the software license key (id1[secret-key1]) 45 from the inserted portable recording medium.

After the software license key (id1[secret-key1]) 45 is acquired, the software license key decrypting section 330 acquires the device identification information (id1) from the identification information storing section 310. Then, using the device identification information (id1), the software license key decrypting section 330 decrypts the software license key (id1[secret-key1]) 45. As a result, a decrypted software decryption key (secret-key1) 46 is obtained. The decrypted software decryption key (secretkey1) 46 is transferred to the software decrypting section 340.

The software decrypting section 340 receives the encrypted software (public-keyl[s1]) 33 sent from the software provision server 100. Then, using the software decryption key (secret-key1) 46, the software decrypting section 340 decrypts the encrypted software (publickeyl[s1]) 33, thus obtaining decrypted software (s1) 34.

The software executing section 350 executes the decrypted software (s1) 34.

In the license management system configured as described above, software is provided to the user to whom a license has been granted, following the procedure explained below. The provision of software can be divided into a process of encrypting developed software and a process of providing the software.

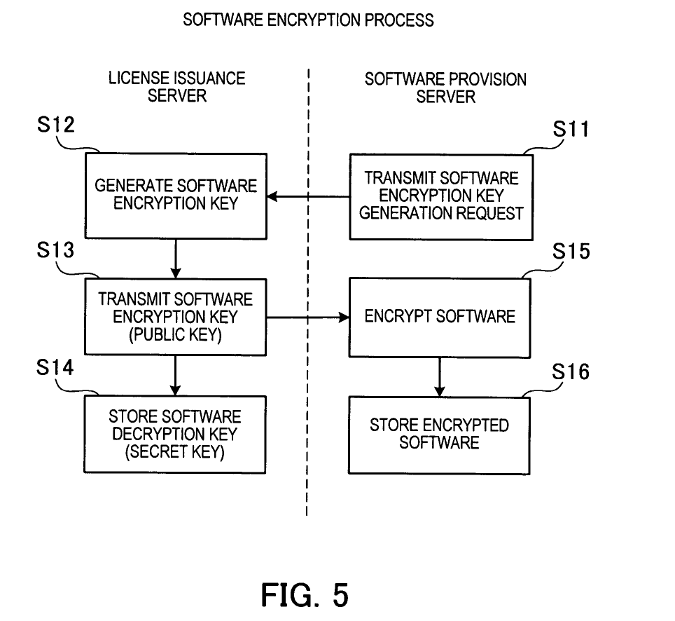

FIG. 5 is a sequence diagram showing a software encryption process according to the first embodiment. In the following, the process shown in FIG. 5 will be explained in order of step number.

[Step S11] An instruction to encrypt the software (s1) 31 is input to the software provision server 100 by the software provider 21, whereupon the encryption key requesting section 110 transmits a software encryption key generation request to the license issuance server 200. The generation of the software encryption key may alternatively be requested to the license issuance authority 22 by mail or the like.

[Step S12] In response to the software encryption key generation request, the software encryption key generating section 210 of the license issuance server 200 generates an encryption key. Specifically, the software encryption key generating section 210 generates the software encryption key (public-key1) 41 and the software decryption key (secret-key1) 42.

[Step S13] Subsequently, the software encryption key generating section 210 transmits the software encryption key (public-key1) 41 to the software provision server 100. The software encryption key (public-key1) 41 may alternatively be sent to the software provider 21 by mail or the like.

[Step S14] Further, the software encryption key generating section 210 stores the software decryption key (secret-key1) 42.

[Step S15] In the software provision server 100, the software encrypting section 120 encrypts the software (s1) 31 by using the software encryption key (public-key1) 41, whereby encrypted software (public-keyl[s1]) 32 is generated.

[Step S16] The software encrypting section 120 then stores the encrypted software (public-keyl[s1]) 32.

In this manner, the software (s1) 31 developed by the software provider is encrypted and the encrypted software (public-keyl[s1]) 32 is stored in the software provision server 100. At this time, the software decryption key (secret-key1) 42 for decrypting the encrypted software (public-keyl[s1]) 32 is stored in the license issuance server 200.

Under the aforementioned circumstances, the user 23 applies for purchase of the software 31 from the software provider 21. Such an application for purchase may be made through online transaction via the Internet etc., for example. Alternatively, purchase of software may be applied for directly by telephone or at a store. After the application for purchase is completed, a software delivery process is carried out.

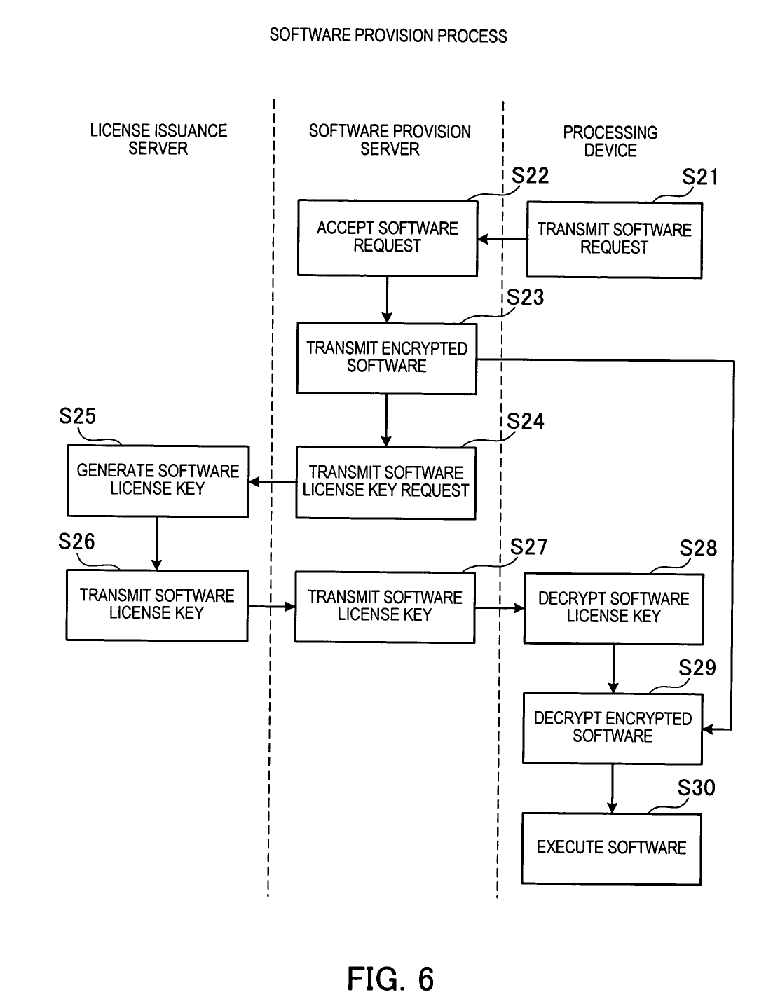

FIG. 6 is a sequence diagram showing a software provision process according to the first embodiment. In the following, the process shown in FIG. 6 will be explained in order of step number.

[Step S21] An instruction to acquire the software (s1) 31 is input to the processing device 300 by the user 23, whereupon the software requesting section 320 transmits a software request to the software provision server 100. The software request transmitted at this time includes the device identification information (id1) acquired from the identification information storing section 310. The software request may additionally include authentication information indicating that the user 23 is a person who duly followed the procedure for purchasing the software 31.

Also, a portable recording medium in which the software request including the device identification information (id1) is stored may be sent by mail or handed directly to the software provider 21.

[Step S22] On receiving the software request, the software request accepting section 130 of the software provision server 100 confirms that the received request is from a person who duly followed the procedure for purchasing the software (s1) 31. After authenticity of the purchaser is confirmed, the software request accepting section 130 instructs the software providing section 140 to provide the software.

[Step S23] On receiving the instruction to provide the software, the software providing section 140 transmits the encrypted software (public-key1[s1]) 32 to the processing device 300. The encrypted software (publickeyl[s1]) 32 may alternatively be stored in a portable recording medium to be sent to the user 23 by mail or the like.

[Step S24] Further, the software request accepting section 130 transmits a software license key request to the license issuance server 200. The software license key request includes the device identification information (id1) 43. Alternatively, the software license key request may be stored in a recording medium to be sent to the license issuance authority 22 by mail or the like.

Steps S23 and S24 may be reversed in order.

[Step S25] On receiving the software license key request, the software license key generating section 220 of the license issuance server 200 encrypts the software decryption key (secret-key1) 42 by using the device identification information (id1) 43 as an encryption key, thereby generating a software license key (id1[secret-key1]) 44.

[Step S26] The software license key generating section 220 transmits the generated software license key (id1[secret-key1]) 44 to the software provision server 100. The software license key (id1[secret-key1]) 44 may alternatively be stored in a portable recording medium to be sent to the software provider 21 by mail or the like.

[Step S27] In the software provision server 100, the software license providing section 150 receives the software license key (id1[secret-key1]) 44 sent from the license issuance server 200. Then, the software license providing section 150 transmits the software license key (id1[secret-key1]) 44 to the processing device 300. Alternatively, the software license key (id1[secret-key1]) 44 may be stored in a portable recording medium to be sent to the user 23 by mail or the like.

[Step S28] In the processing device 300, the software license key decrypting section 330 decrypts the software license key (id1[secret-key1]) 44 by using, as a decryption key, the device identification information (id1) 43 stored in the identification information storing section 310, thereby generating the software decryption key (secretkey1) 46. The generated software decryption key (secretkey1) 46 is transferred to the software decrypting section 340.

[Step S29] Using the software decryption key (secret-key1) 46 as a decryption key, the software decrypting section 340 decrypts the encrypted software (public-keyl[s1]) 33, thereby obtaining the plaintext software (s1) 34.

[Step S30] The software executing section 350 executes the software (s1) 34.

In this manner, the software lock mechanism provider (license issuance authority 22) issues the software encryption key 41 to the software provider 21 as well as the software license key 44 in compliance with a request from the user 23, whereby the advantages described below are obtained.

In the first embodiment, the software 31 is provided after being encrypted, and also the software decryption key 42 is provided to the processing device after being encrypted using the device identification information 43 that cannot be modified by the user. It is therefore possible to securely prevent illegal use of the software.

Specifically, since the software 31 is encrypted when it is provided, it is not possible to execute the software 31 or analyze the contents of processes performed thereby unless the software 31 is decrypted. Accordingly, the software 31 can be prevented from being used illegally through falsification of the provided software.

Moreover, the decryption requires the device identification information 43 which is set at the time of shipment from a factory and which cannot be modified by users. Since the software license key 45 needs to be decrypted by using the device identification information 43, the software 31 cannot be executed by other devices. Accordingly, the software 31 is more difficult to illegally use and is protected more securely, compared with the case of using a machine identification code etc. defined by the OS.

Also, the software provider 21 can make use of software lock (software protection) without the need to bring the software 31 itself to the license issuance authority, which is a third-party organization (thus ensuring high efficiency and copyright protection). Thus, when the version of the software 31 is upgraded, for example, the upgraded version may be encrypted using the software encryption key 41 already provided, making it unnecessary to again follow a similar procedure such as reissue of license. It is therefore possible to lighten the burden imposed on the software provider 21 in connection with software protection.

Further, the software decryption key 42 is managed by the software lock mechanism provider (license issuance authority 22). Thus, if the license issuance server 200 is operated with high security, the software decryption key 42 can be prevented from being acquired illegally by a third party. For example, security specialists may be staffed for the license issuance server 200 to monitor the system operation status and to promptly cope with an illegal access in the event the server is illegally accessed. Consequently, the software provision server 100 need not be operated with unnecessarily high security, thus lightening the burden on the software provider 21.

The software 31 may be made accessible from the software provision server 100 only when the software is encrypted, and inaccessible from the server 100 after the encryption. This makes it impossible for a third party to acquire the non-encrypted software 31 even if he/she illegally accesses the software provision server 100 during operation thereof.

The software lock mechanism provider (license issuance authority 22) may charge the software provider 21 for the service of maintaining secrecy of the software decryption key 42. In this case, each time the software provider 21 makes use of software lock (software protection) (each time the software license key 44 is provided), for example, a corresponding charge may be collected.

Also, the software encryption key generating section 210 generates a pair of public and secret keys for each package of software, and the public key is sent to the software provider while the secret key is used as the software license key, so that the software provider 21 cannot issue licenses freely. This permits a third-party organization to objectively reckon the quantity of packages of the software 31 sold by the software provider 21.

For example, the developed software 31 may include a different developer's patented technique (motion picture compression technique etc.) as part of its functions. In such cases, the software 31 can be put on sale on condition that the patentee of the patented technique grants a license for the patented technique. If the license agreement reached prescribes that a royalty corresponding to the quantity of sales of the software 31 should be paid, then the quantity of the sales must be accurately calculated. According to the first embodiment in which the number of licenses issued is managed by the license issuance authority 22 which is a third-party organization, an actual quantity of sales can be calculated with accuracy. Consequently, neither the licenser nor the licensee will doubt the amount of royalty to be settled.

Further, the software vendor (software provider 21) has only to encrypt the software to protect same. Namely, software logic for protecting the application software need not be added to the program, so that the software development efficiency improves.

The following describes examples of application of the license management system according to the first embodiment.

The software request output from the software requesting section 320 may include information about the conditions of use of the software (information about the number of executions or the range of execution of the software), so that the conditions of use of the software may be set in the software license key 44.

In this case, after confirming that a charge corresponding to the conditions of use of the software, included in the software request, has been paid, the software request accepting section 130 transmits a software license key request including the conditions of use of the software to the license issuance server 200 through the network. The software license key request may alternatively be stored in a portable recording medium to be sent to the license issuance authority 22 by mail or the like.

The software license key generating section 220 in the license issuance server 200 encrypts the software decryption key 42 together with the conditions of use of the software, to generate a software license key 44.

The software license key 44 is decrypted by the software license key decrypting section 330 of the processing device 300, whereupon the software decryption key 46 as well as the conditions of use of the software are restored. The software executing section 350 looks up the conditions of use of the software and performs only those functions which are allowed by the conditions of use of the software.

By generating the software license key 44 so as to include information about the conditions of use of software, it is also possible to have the software executed within the limits allowed by the conditions of use of licensed software (software price).

Also, only part of the software 31 may be encrypted by the software encrypting section 120. For example, the software provider 21 selects a range of software components (important files requiring protection, etc.) that should be encrypted, whereupon the software encrypting section 120 encrypts only the selected range and includes information about the selected range (file list etc.) in the encrypted software 32. Subsequently, the software decrypting section 340 decrypts the selected range. By providing the software 31 only part of which is encrypted, it is possible to shorten the time required for the software decryption process.

In the above examples, the license issuance server 200 and the software provision server 100 perform respective separate functions, but the provision of software and the issuance of license may be carried out by a single server (e.g., software provision server).

[Second Embodiment]

A second embodiment will be now described. In the second embodiment, the identification information of the processing device is stored in hardware (hereinafter referred to as hardware key) having high tamper resistance (high resistance to physical attack) and then provided to the user. The user cannot execute the software unless he/she uses a device having device identification information coinciding with the identification information stored in the hardware key.

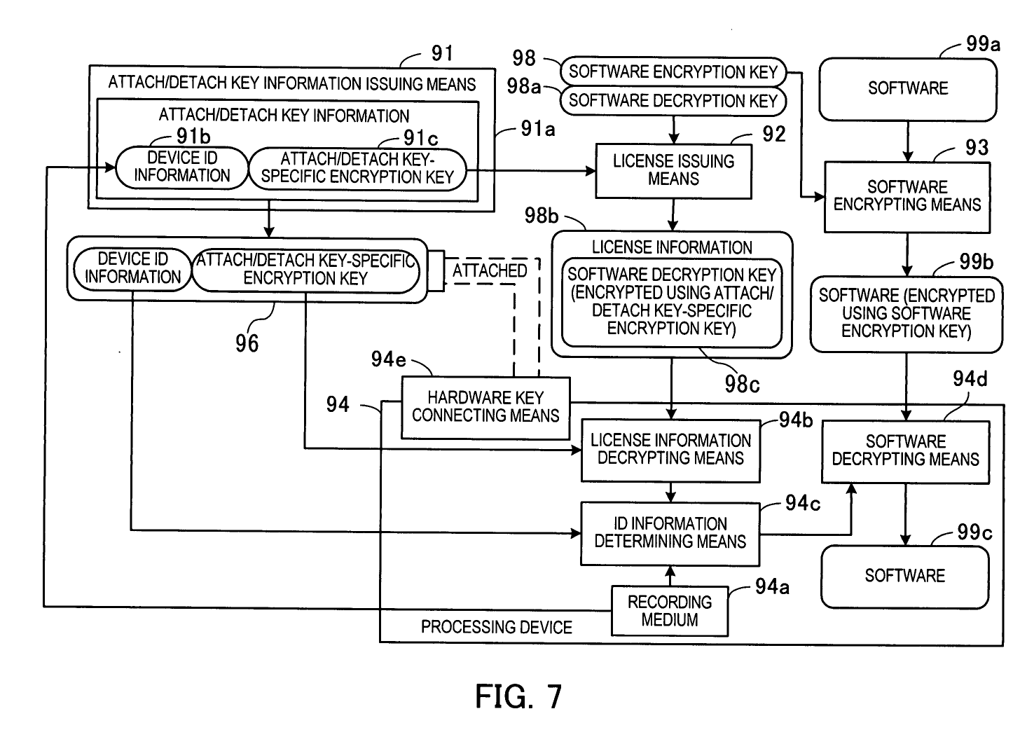

FIG. 7 is a conceptual diagram of invention applied to the second embodiment. A license management system comprises attach/detach key information issuing means 91, license issuing means 92, software encrypting means 93, and a processing device 94.

In response to an attach/detach key information generation request, the attach/detach key information issuing means 91 generates attach/detach key information 91a including device identification information 91b and an attach/detach key-specific encryption key 91c. The attach/detach key information generation request includes the device identification information 91b fixedly recorded on a recording medium 94a in the processing device 94 which is a target of permission to run software 99a. The attach/detach key information issuing means 91 records the generated attach/detach key information 91a on a hardware key 96 which can be attached to and detached from the processing device 94. The hardware key 96 is given to the user of the processing device 94.

In response to a software license issue request, the license issuing means 92 encrypts a software decryption key 98a by using the attach/detach key-specific encryption key 91c, and outputs license information 98b including the encrypted software decryption key 98c. The software decryption key 98a is key information for decrypting encrypted software 99b. The output license information 98b is transferred to the processing device 94.

The software encrypting means 93 encrypts the software 99a by using a software encryption key 98, and transfers the encrypted software 99b to the processing device 94.

The processing device 94 includes the recording medium 94a, license information decrypting means 94b, identification information determining means 94c, software decrypting means 94d, and hardware key connecting means 94e.

The recording medium 94a has the device identification information 91b fixedly recorded thereon. The hardware key connecting means 94e reads the attach/detach key information 91a from the hardware key 96 when the hardware key 96 is attached thereto. When input with the license information 98b including the encrypted software decryption key 98c for decrypting the software 99a, the license information decrypting means 94b decrypts the software decryption key 98c by using the attach/detach key-specific encryption key 91c. The identification information determining means 94c determines the sameness of the device identification information 91b included in the attached hardware key 96 with that recorded on the recording medium 94a. If it is judged by the identification information determining means 94c that the two sets of device identification information are the same, the software decrypting means 94d decrypts the encrypted software 99b by using the software decryption key 98a decrypted by the license information decrypting means 94b, thereby generating non-encrypted software 99c.

With the license management system described above, only the processing device 94 to which the correct hardware key 96 is attached can decrypt the license information 98b and thus the encrypted software 99b. Moreover, since the device identification information 91b is stored in the hardware key 96, the software 99b can be decrypted only in the processing device of which the device identification information coincides with that stored in the hardware key.

Users of such software may include business enterprises. To operate a computer system in a corporation, various kinds of software packages are used. In the case of configuring an intranet within a corporation, for example, software for performing various functions, such as firewall, DNS (Domain Name System) server, WWW (World Wide Web) server and URL (Uniform Resource Locator) filtering, needs to be installed on a server computer. Further, such an in-house network needs to be kept in operation all the time. Accordingly, a system configuration is employed wherein the individual functions are installed on multiple computers, so that in the event some computers develop fault, the required functions can be recovered by other computers.

Where the system is configured in this manner, it is necessary that the required software be installed on each computer and also that a license for use of the software be obtained. If licenses involving numerous computers are managed individually, the burden on the system administrator greatly increases.

In the second embodiment, therefore, a license management system is provided which permits unified management of software programs executed by a plurality of computers interconnected by a network.

In the following, the second embodiment will be explained taking, as an example, a processing device which permits a desired number of computer functions (processor cartridges) to be incorporated in a single chassis. The identification information of the processing device is, in this case, set in the chassis. Accordingly, in the following description of the second embodiment, the device identification information is referred to as chassis ID.

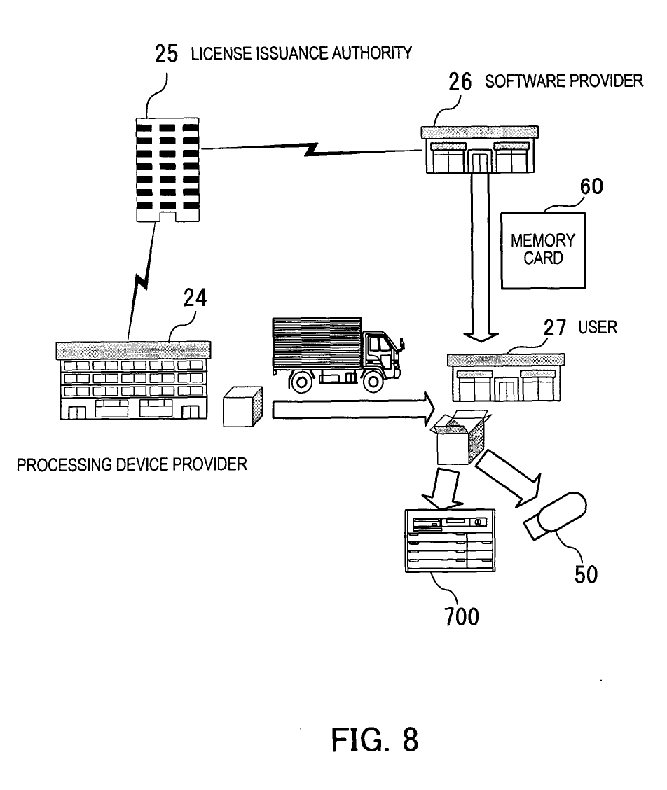

FIG. 8 is a conceptual diagram of a license management system according to the second embodiment. As shown in FIG. 8, operation of the system of the second embodiment involves a processing device provider 24, a license issuance authority 25, a software provider 26, and a user 27.

The processing device provider 24 sells a processing device 700 to the user 27. The processing device 700 comprises a chassis and a processor module which can be mounted to the chassis. Every purchaser of the processing device 700 is given a hardware key 50 necessary for executing software. The hardware key 50 is a storage device with high tamper resistance. For example, a flash memory connectable to USB (Universal Serial Bus) may be used as the hardware key.

The license issuance authority 25 provides the processing device provider 24 with the hardware key 50 storing attach/detach key information therein. Also, the license issuance authority 25 provides the software provider 26 with an encryption key (application encryption key) for encrypting software, as well as software license information.

The software provider 26 develops application software (hereinafter merely referred to as application) and sells the developed application to users. The application is recorded on a memory card 60, together with software for performing basic functions, such as OS, and is provided to the user 27. When recording the application on the memory card 60, the software provider 26 records the application which has been encrypted using the encryption key received from the license issuance authority 25.

The user 27 purchases the processing device 700 from the processing device provider 24 and also purchases the memory card 60 from the software provider 26. Then, the user 27 connects the hardware key 50 to the processing device 700 and inserts the memory card 60 into the processor module within the processing device 700, whereupon the processing device 700 is ready to execute the OS and application recorded on the memory card 60.

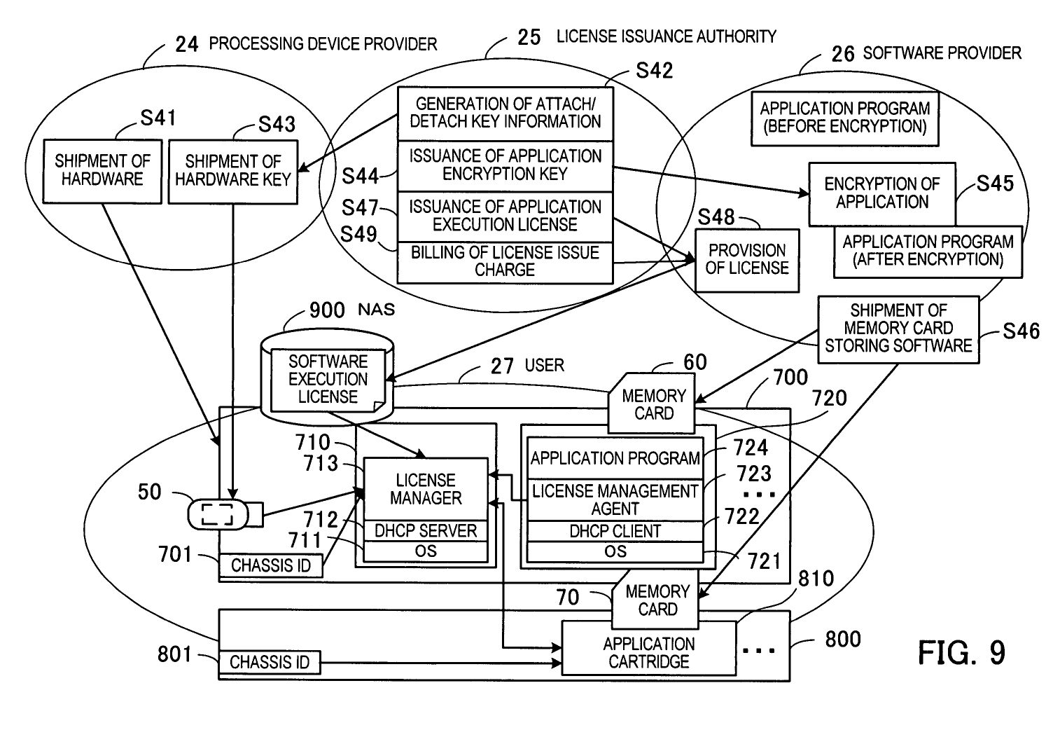

FIG. 9 is a conceptual diagram of a license management mechanism according to the second embodiment. First, the processing devices 700 and 800 are sold from the processing device provider 24 to the user 27 (Step S41). At this time, attach/detach key information including the chassis ID of the processing device 700 is generated at the license issuance authority 25 (Step S42). The generated attach/detach key information is recorded on the hardware key 50 at the license issuance authority 25 and then shipped to the user 27 via the processing device provider 24 (Step S43).

Also, the license issuance authority 25 issues an application encryption key and an application decryption key and sends the application encryption key to the software provider 26 (Step S44). In the following, the pair of application encryption and decryption keys will be referred to as “application encryption/decryption key”. Using the application encryption key, the software provider 26 encrypts a non-encrypted application program (Step S45). The encrypted application program is stored in the memory card 60 and then shipped to the user 27 (Step S46).

Further, the license issuance authority 25 issues an application execution license (Step S47). The application execution license is supplied to the user 27 via the software provider 26 and stored in a NAS (Network Attached Storage) 900 (Step S48). The NAS 900 is a file management storage device connected to the in-house LAN (Local Area Network) of the user 27. The application execution license has only to be stored in a recording medium accessible from the processing device 700; namely, it may be stored in the storage device of a computer other than the NAS 900.

The user 27 connects the processing devices 700 and 800 purchased from the processing device provider 24 to the network, and attaches the hardware key 50 to the processing device 700. The processing device 700 has a processor cartridge for management (management cartridge 710) and a plurality of processor cartridges for executing applications (application cartridges 720). The management cartridge 710 has incorporated therein a license manager 713, besides such functions as an OS 711 and a DHCP (Dynamic Host Configuration Protocol) server 712. The license manager 713 acquires the software execution license from the NAS 900 and decrypts the software execution license by using the attach/detach key recorded on the hardware key 50. Then, the license manager 713 determines the coincidence of the chassis ID set in the chassis of the processing device 700 with that stored in the hardware key 50. If the chassis IDs coincide, the license manager 713 permits the other application cartridges to execute the software under the licensing conditions as specified by the software execution license.

The memory card 60 is inserted in an application cartridge 720. The application cartridge 720 is connected to the management cartridge 710 inside the processing device 700. The application cartridge 720 reads in programs recorded on the memory card 60, such as OS and application, and performs predetermined functions.

The functions performed by the application cartridge 720 are an OS 721, a DHCP client 722, a license management agent 723, and an application 724. Upon receipt of a permission to execute the application from the license manager 713, the license management agent 723 allows the application cartridge 720 to execute the application 724.

A memory card 70 is inserted in an application cartridge 810 of the processing device 800, whereby the application cartridge 810 also can be made to perform functions similar to those of the application cartridge 720. In this case, the application cartridge 810 transfers a chassis ID 801 set in the chassis of the processing device 800 to the license manager 713, thereby to obtain a permission to execute the application.

In this manner, the license manager 713 manages the licenses of the software executed in the individual application cartridges, thus enabling collective management of the licenses of the entire system constituted by a large number of computers. Moreover, the processing device 700, 800 is allowed to execute the software only when the chassis ID thereof coincides with the chassis ID set in the hardware key 50, and therefore, it is possible to prevent the software from being used illegally by means of unauthorized copy of device-specific information.

The processing devices 700 and 800 each permit a desired number of processor cartridges (management cartridges and application cartridges) to be mounted therein. The processor cartridges are connected to the LAN as soon as they are mounted to the processing devices 700 and 800. In the following, the hardware configurations of the processing device 700, 800 and processor cartridge used in the second embodiment will be described.

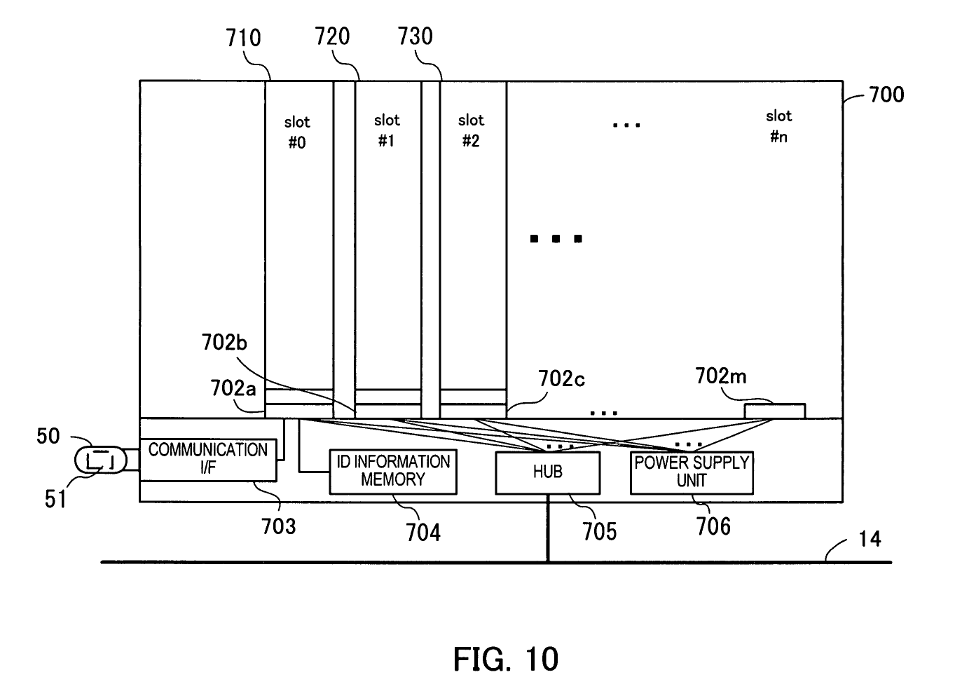

FIG. 10 shows an exemplary hardware configuration of the processing device. The processing device 700 has at least one slot (slot #0 to slot #n) for receiving a processor cartridge. The slots are provided with connectors 702a to 702m, respectively, to which processor cartridges are to be connected. In the example shown in FIG. 10, the management cartridge 710 is connected to the connector 702a, and the application cartridges 720 and 730 are connected to the connectors 702b and 702c, respectively.

The chassis of the processing device 700 is provided with a communication interface (I/F) 703, an identification information memory 704, a hub 705, a power supply unit 706, etc. The hub 705 may be a switching hub having a switching function. Also, the hub 705 and the power supply unit 706 may not necessarily be built into the chassis and may be connected externally to the chassis.

The communication I/F 703 is a communication interface capable of communicating with the hardware key 50. A USB interface, for example, may be used for the purpose.

The identification information memory 704 is a recording medium on which the chassis ID is recorded, and a read-only semiconductor memory is used, for example. The identification information memory 704 is connected only to the connector 702a associated with the slot #0, and accordingly, only the management cartridge 710 connected to the slot #0 can directly read the chassis ID recorded in the identification information memory 704. The identification information memory 704 may be connected to a different slot.

The hub 705 is connected to a LAN 14 as well as to the connectors 702a to 702m of the respective slots. Thus, the processor cartridges connected to the connectors 702a to 702m are connected to the LAN 14.

The power supply unit 706 supplies electric power to the communication I/F 703, identification information memory 704 and hub 705 arranged in the chassis of the processing device 700, as well as to the connectors 702a to 702m. Accordingly, the processor cartridges connected to the connectors 702a to 702m are supplied with electric power from the power supply unit 706.

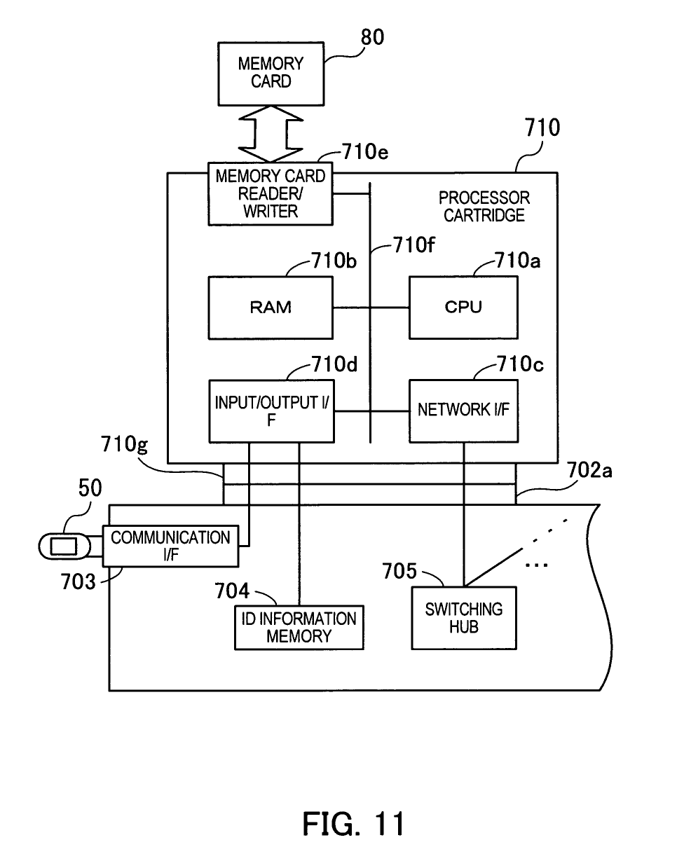

FIG. 11 shows an exemplary hardware configuration of a processor cartridge. In FIG. 11, the management cartridge 710 is illustrated as a typical example of processor cartridge, but the application cartridge also has a hardware configuration similar to that of the management cartridge.

In the management cartridge 710, a CPU 710a, a RAM 710b, a network interface (I/F) 710c, an input/output interface (I/F) 710d and a memory card reader/writer 710e are interconnected by a bus 710f. Also, the management cartridge 710 is provided with a connector 710g. The connector 710g is connected to the connector 702a arranged in the chassis of the processing device 700, whereby the circuitry in the management cartridge 710 is electrically connected to the circuitry in the chassis of the processing device 700.

The CPU 710a controls the entire management cartridge 710. The RAM 710b temporarily stores programs and data necessary for the processing by the CPU 710a. The network I/F 710c communicates via the hub 705 with other devices (e.g., other application cartridges) connected to the LAN 14. The input/output I/F 710d, which is connected to the communication I/F 703 and the identification information memory 704, reads data from the hardware key 50 and the identification information memory 704 and transfers the read data to the CPU 710a etc.

Computers are also used for the processing performed at the processing device provider 24, the license issuance authority 25 and the software provider 26 shown in FIG. 9. Such computers have a hardware configuration similar to that of the computer 100 of the first embodiment, shown in FIG. 3. The computers used at the processing device provider 24, the license issuance authority 25 and the software provider 26 are referred to herein as a processing device management server, a license issuance server and a software provision server, respectively.

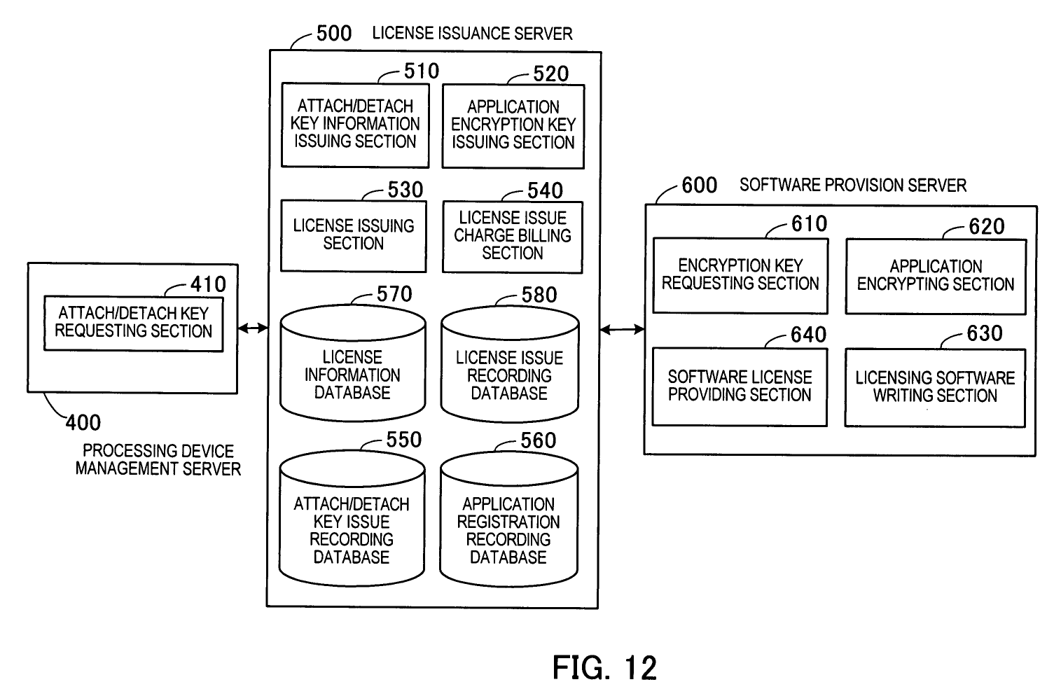

FIG. 12 is a block diagram illustrating processing functions of the respective server computers. In FIG. 12, only those elements which are included in the respective devices are illustrated and their connections (information exchange relationships) are omitted. The connections of the elements are shown in the figures described below, which illustrate functions of the respective elements. As shown in FIG. 12, the processing device management server 400 and the license issuance server 500 are connected by a network, and also the license issuance server 500 and the software provision server 600 are connected by a network. It is not essential, however, that the processing device management server 400, the license issuance server 500 and the software provision server 600 be connected by a network, and information may be transferred from one server to another by means of a portable recording medium or the like.

The processing device management server 400 is a computer installed at the provider (e.g., a factory or a warehouse) of the processing devices 700 and 800 or at the license issuance authority 25, for managing the stock of the processing devices. The processing device management server 400 has an attach/detach key requesting section 410 as a function related to the second embodiment.

The attach/detach key requesting section 410 transmits an attach/detach key request including the chassis ID set in the chassis of the processing device, to the license issuance server 500 through the network. The attach/detach key request may alternatively be stored in a portable recording medium to be sent to the license issuance authority 25 by mail or the like.

The license issuance server 500 is a computer having the function of managing licenses for application software. The license issuance server 500 has an attach/detach key information issuing section 510, an application encryption/decryption key issuing section 520, a license issuing section 530, a license issue charge billing section 540, an attach/detach key issue recording database 550, an application registration recording database 560, a license information database 570, and a license issue recording database 580.

In response to the attach/detach key request from the processing device management server 400, the attach/detach key information issuing section 510 provides attach/detach key information. Specifically, on receiving the attach/detach key request, the attach/detach key information issuing section 510 generates identification information (attach/detach key ID) of an attach/detach key and an attach/detach key-specific encryption key. Then, the attach/detach key information issuing section 510 generates attach/detach key information including the attach/detach key ID, the chassis ID included in the attach/detach key request, and the attach/detach key-specific encryption key, and transmits the thus-generated attach/detach key information to the processing device management server 400. Alternatively, the attach/detach key information may be stored in a portable recording medium to be sent to the processing device provider 24 by mail or the like.

In response to an application encryption key request from the software provision server 600, the application encryption/decryption key issuing section 520 issues an application encryption key and an application decryption key for decrypting data encrypted using the application encryption key.

Specifically, the issuing section 520 generates identification information (application ID) of the application and an application encryption/decryption key corresponding to the application ID. The generated application encryption/decryption key is stored in the application registration recording database 560. Also, the application encryption key is supplied to the software provision server 600.

In response to a license request from the software provision server 600, the license issuing section 530 issues an license for the application. Specifically, on receiving the license request, the license issuing section 530 generates an application execution license indicating the contents of a license to be granted to the user 27, then encrypts the generated application execution license, and transmits the encrypted license to the software provision server 600.

The license issue charge billing section 540 monitors the status of issuance of licenses (number of devices executing the application) and calculates a charge for licenses issued at the request of the software provider 26. Based on the license issue charge calculated by the license issue charge billing section 540, the license issuance authority 25 bills the software provider 26.

The attach/detach key issue recording database 550 holds the contents of the attach/detach key information issued by the attach/detach key information issuing section 510.

In the application registration recording database 560 is registered information (application information) about applications with respect to which the license issue service is provided. For example, the application encryption/decryption keys are stored in the application registration recording database 560.

The license information database 570 stores the license information which has been issued to the user 27.

The license issue recording database 580 stores past records on issuance of licenses. By looking up the license issue recording database 580, it is possible to total the licenses issued for the respective applications.

The software provision server 600 has an encryption key requesting section 610, an application encrypting section 620, a licensing software writing section 630, and a software license providing section 640.

In response to an input operation etc. of the software provider 26, the encryption key requesting section 610 transmits an application encryption key request to the license issuance server 500. For example, when the development of the application is completed, the application encryption key request is transmitted.

The application encrypting section 620 encrypts the application program by using the application encryption key sent from the license issuance server 500.

The licensing software writing section 630 writes the encrypted application program along with other system software (OS, license management agent, etc.) into the memory card 60.

In response to a license request from the processing device 700 which has been delivered to the user 27, the software license providing section 640 transmits an application execution license request to the license issuance server 500. On receiving an application execution license from the license issuance server 500, the software license providing section 640 transfers the received license to the user 27. For example, the application execution license is transferred through the network to the NAS 900 administered by the user 27.

In the following, exemplary data structures of various types of information used in the second embodiment will be described.

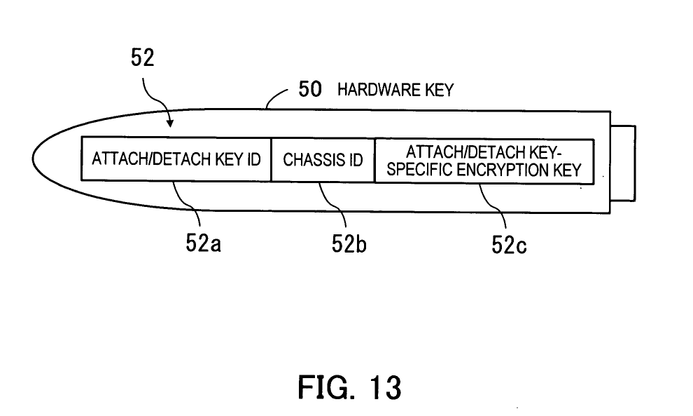

FIG. 13 shows an exemplary data structure of the attach/detach key information stored in the attach/detach key. The attach/detach key information 52 stored in the hardware key 50 includes an attach/detach key ID 52a, a chassis ID 52b, and an attach/detach key-specific encryption key 52c. The attach/detach key ID 52a is identification information uniquely identifying the hardware key 50. The chassis ID 52b is identification information (chassis ID) set in the processing device with respect to which the license is issued. The attach/detach key-specific encryption key 52c is an encryption key generated in association with the hardware key 50.

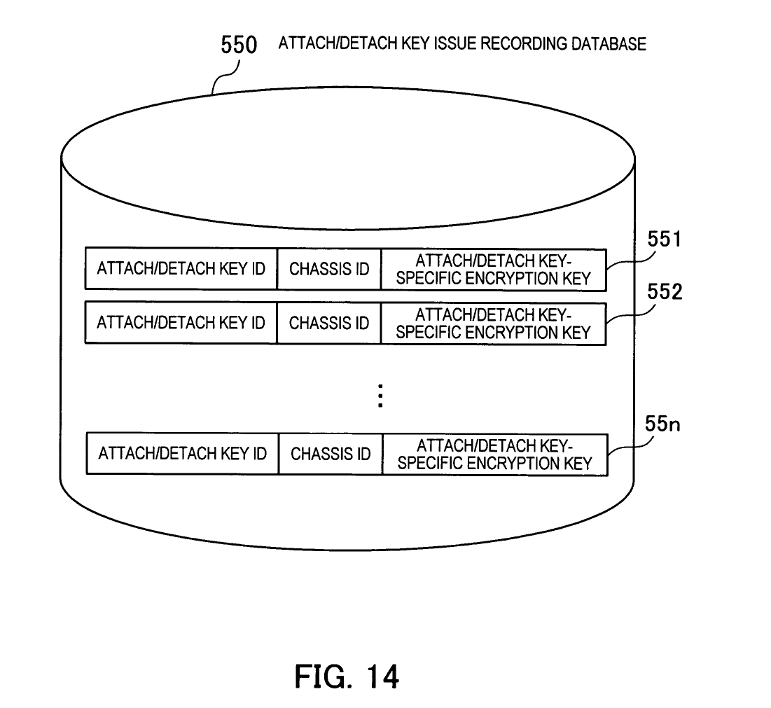

FIG. 14 shows an exemplary data structure of the attach/detach key issue recording database. The attach/detach key issue recording database 550 stores a plurality of sets of attach/detach key information 551, 552, . . . 55n, which have been issued by the attach/detach key information issuing section 510.

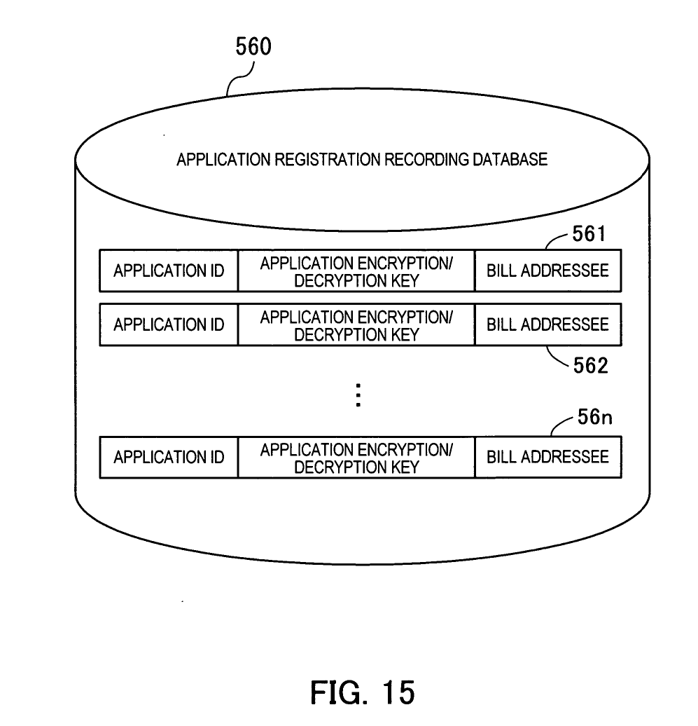

FIG. 15 shows an exemplary data structure of the application registration recording database. In the application registration recording database are registered a plurality of sets of application information 561, 562, . . . , 56n. Each application information 561, 562, . . . , 56n includes information about an application ID, an application encryption/decryption key and a bill addressee. The application ID is identification information of an application with respect to which the license issue service is provided. The application encryption/decryption key is key information used for encrypting and decrypting the application with respect to which the license issue service is provided. The bill addressee is information specifying the software provider 26 who has requested the license issue service for the application. The bill addressee includes the address, telephone number, customer reference number, billing method (e.g., information on the account of a banking institution from which the charge is paid), etc. of the software provider 26.

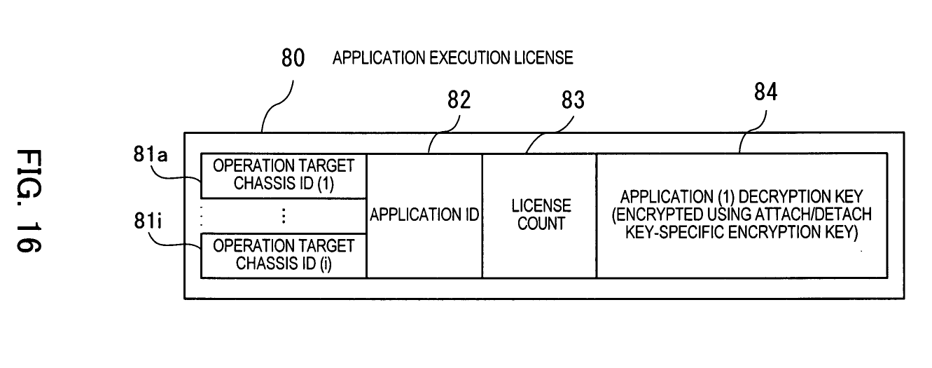

FIG. 16 shows an exemplary data structure of the application execution license. The application execution license 80 includes one or more chassis IDs 81a, . . . , 81i, an application ID 82, a license count 83, and an application decryption key 84. The chassis IDs 81a, . . . , 81i are the chassis IDs set in the respective processing devices that the user 27 causes to operate in cooperation. The application ID 82 is the identification information of an application of which the execution is permitted, and the license count 83 is the number of processor cartridges that are allowed to execute the application simultaneously. The application decryption key 84 is a decryption key for decrypting the application. The application decryption key 84 included in the application execution license 80 is encrypted by means of the attach/detach key-specific encryption key.

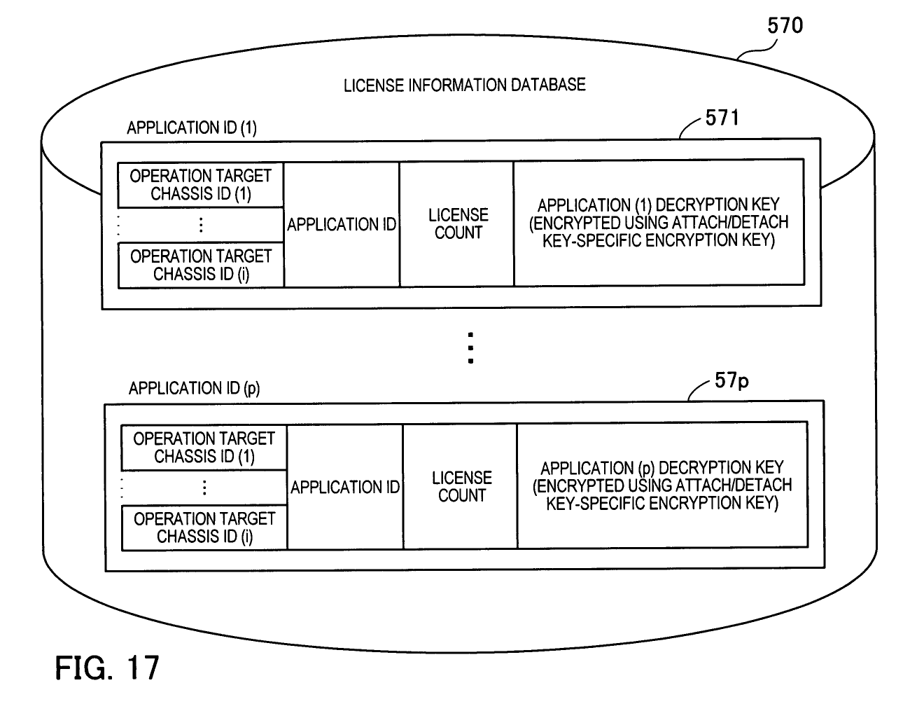

FIG. 17 shows an exemplary data structure of the license information database. The license information database 570 stores license information 571, . . . , 57p in association with respective applications. Each license information 571, . . . , 57p is registered in a manner associated with the corresponding application ID. The data structure of the license information is identical with that of the application execution license 80 shown in FIG. 16.

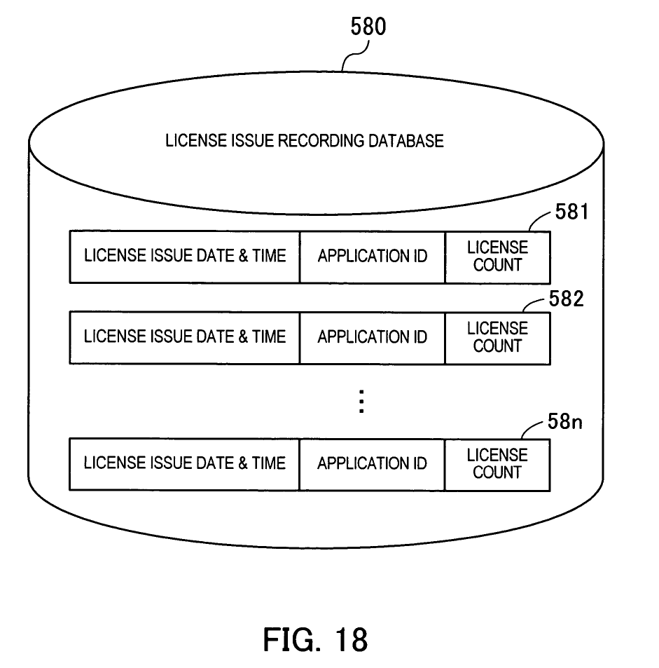

FIG. 18 shows an exemplary data structure of the license issue recording database. The license issue recording database 580 stores a plurality of license issue records 581, 582, . . . , 58n. Each of the license issue records 581, 582, . . . , 58n includes information such as license issue date and time, application ID and license count.

The license management system configured as described above makes it possible to allow only the user 27, who is an authorized licensee, to execute the application provided by the software provider 26. The processing performed by the license management system of the second embodiment can be roughly divided into a hardware key generation process, an application provision process, a license provision process, a license issue charge calculation process, and a license-compliant application execution process.

First, the hardware key generation process will be described.

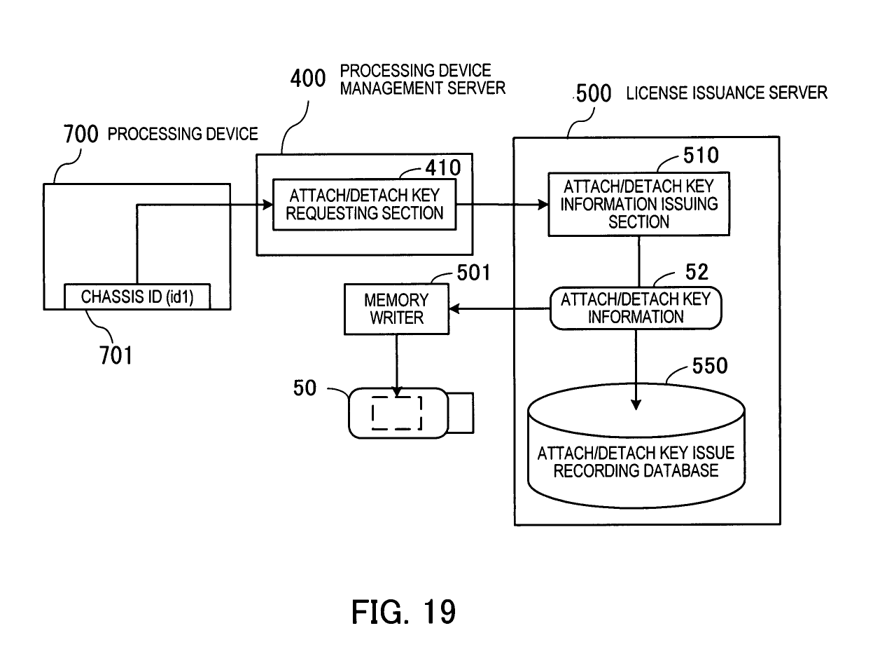

FIG. 19 is a conceptual diagram illustrating the hardware key generation process. When a hardware key is to be generated, the chassis ID of the processing device 700 is transmitted, together with an attach/detach key request, from the processing device management server 400 to the license issuance server 500 through the network. The chassis ID may alternatively be stored in a portable recording medium to be sent to the license issuance authority 25. In this case, the operator at the license issuance authority 25 inserts the portable recording medium in the license issuance server 500 and inputs an attach/detach key request including the chassis ID to the license issuance server 500.

Specifically, the attach/detach key requesting section 410 of the processing device management server 400 acquires the chassis ID 701 of the processing device 700. In the case where the chassis ID is stored in a production management device (not shown) for managing the process of manufacture of processing devices, for example, the chassis ID may be acquired from such a production management device. Alternatively, the chassis ID 701 may be manually input to the processing device management server 400 to notify the attach/detach key requesting section 410 of the chassis ID 701.

After acquiring the chassis ID 701, the attach/detach key requesting section 410 transmits an attach/detach key request including the chassis ID 701 to the license issuance server 500 through the network. The attach/detach key request is received by the attach/detach key information issuing section 510 of the license issuance server 500. The attach/detach key request including the chassis ID 701 may alternatively be transferred to the license issuance server 500 by means of other information transfer means (e.g., portable recording medium) than network.

In the attach/detach key information issuing section 510, the chassis ID 701 received from the processing device management server 400 is associated with an attach/detach key ID and an attach/detach key-specific encryption key, to generate attach/detach key information 52. The generated attach/detach key information 52 is written into a hardware key by means of a memory writer 501. Also, the attach/detach key information issuing section 510 stores the issued attach/detach key information 52 in the attach/detach key issue recording database 550.

The hardware key 50 storing the attach/detach key information 52 is delivered via the processing device provider 24 to the user 27. Alternatively, the hardware key 50 may be delivered directly to the user 27 from the license issuance authority 25.

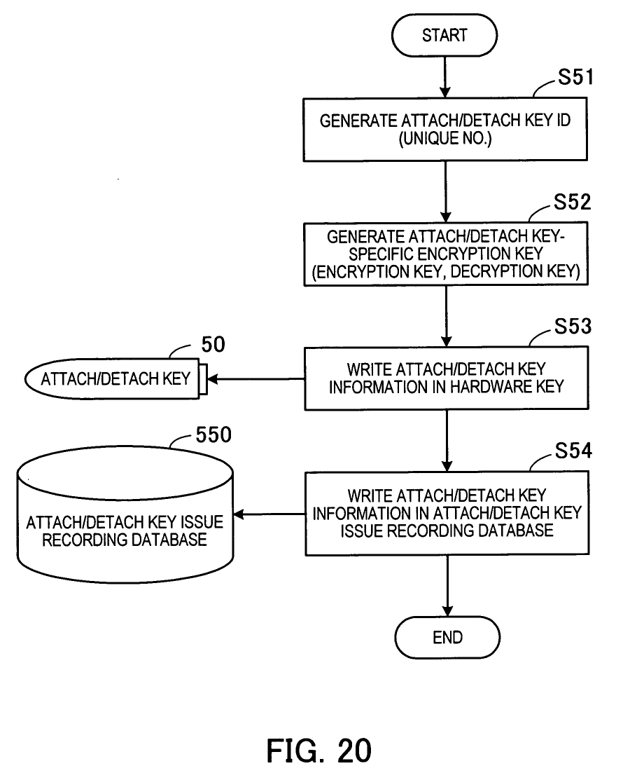

FIG. 20 is a flowchart illustrating the process of the attach/detach key information issuing section. In the following, the process shown in FIG. 20 will be described in order of step number. The process explained below is executed when the attach/detach key request is transferred to the license issuance server 500.

[Step S51] The attach/detach key information issuing section 510 generates an attach/detach key ID. For the attach/detach key ID, a unique number is used.

[Step S52] The attach/detach key information issuing section 510 generates an attach/detach key-specific encryption key. The attach/detach key-specific encryption key serves as both an encryption key for encrypting license information and a decryption key for decrypting the license information.

[Step S53] The attach/detach key information issuing section 510 writes attach/detach key information (attach/detach key ID, chassis ID, attach/detach key-specific encryption key) into the hardware key 50.

[Step S54] The attach/detach key information issuing section 510 writes the generated attach/detach key information in the attach/detach key issue recording database 550.

In this manner, the hardware key 50 having the attach/detach key information 52 recorded thereon is generated and provided, together with the processing device 700, to the user 27.

The application provision process will be now described.

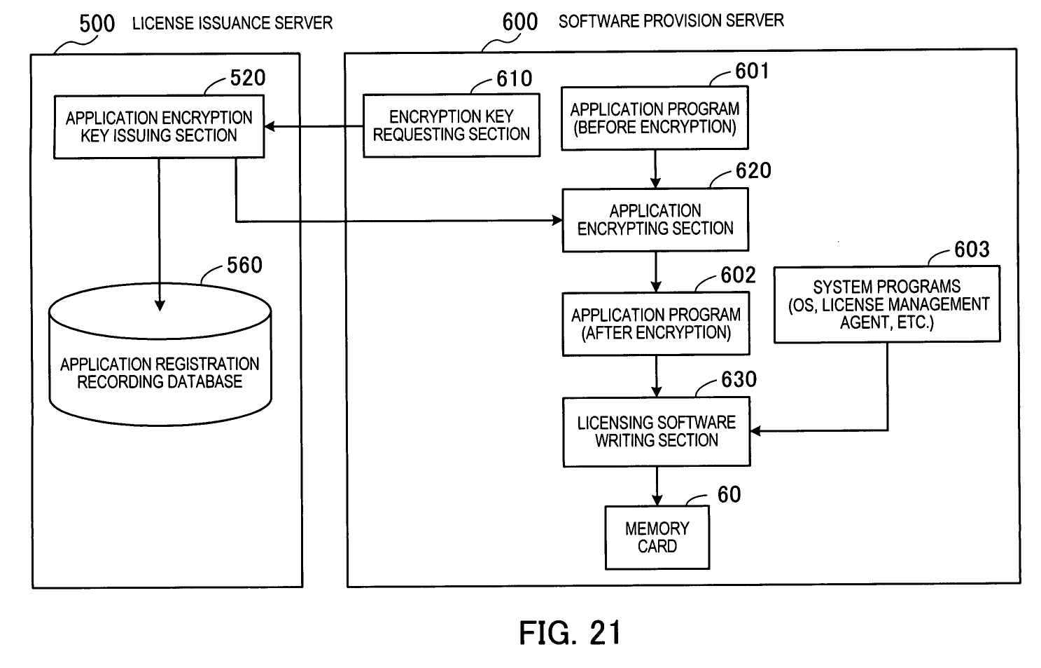

FIG. 21 is a conceptual diagram illustrating the application provision process. When the development of an application program (before encryption) 601 is completed at the software provider 26, an application encryption key request is transmitted from the encryption key requesting section 610 to the license issuance server 500 through the network. The application encryption key request may alternatively be transferred to the license issuance server 500 by means of other information transfer means than network. For example, the software provider 26 may request the license issuance authority 25 by telephone or electronic mail to issue an application encryption key, and the operator at the license issuance authority 25 may input an application encryption key request to the license issuance server 500.

Thereupon, the application encryption/decryption key issuing section 520 of the license issuance server 500 generates an application encryption/decryption key and transmits only the application encryption key out of the two keys to the software provision server 600. At this time, the application encryption/decryption key issuing section 520 stores the generated application encryption/decryption key in the application registration recording database 560. The application encryption key may alternatively be transferred to the software provision server 600 by means of other information transfer means than network. For example, the application encryption key may be stored in a portable recording medium to be sent to the software provider 26 by mail or the like. The software provider 26 inserts the received portable recording medium in the software provision server 600 to cause the server 600 to read the application encryption key.

The application encryption key sent to the software provision server 600 is received by the application encrypting section 620. Using the application encryption key, the application encrypting section 620 encrypts the non-encrypted application program 601, thereby generating an encrypted application program 602.

Subsequently, the licensing software writing section 630 writes the application program 602, along with system programs 603, in the memory card 60. The system programs 603 include programs for performing functions such as OS, license management agent and DHCP client.

The memory card 60 on which the software has been recorded in this manner is provided to the user 27.

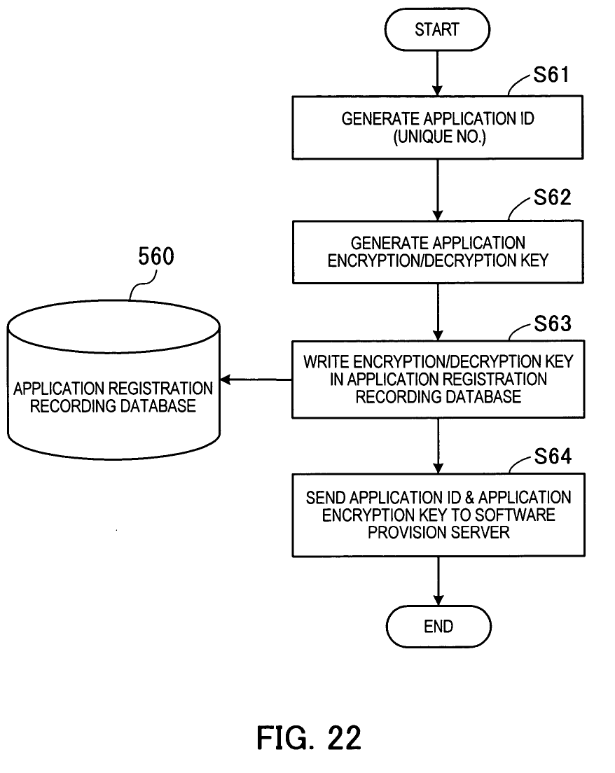

FIG. 22 is a flowchart illustrating the process of the application encryption/decryption key issuing section. In the following, the process shown in FIG. 22 will be described in order of step number.

[Step S61] The application encryption/decryption key issuing section 520 generates an application ID. The application ID is a unique number assigned to each application.

[Step S62] The application encryption/decryption key issuing section 520 generates an application encryption/decryption key. The application encryption and decryption keys are used to encrypt and decrypt the application, respectively.

[Step S63] The application encryption/decryption key issuing section 520 writes the application encryption/decryption key in the application registration recording database 560.

[Step S64] The application encryption/decryption key issuing section 520 affixes the application ID to the application encryption key and transmits the ID-affixed encryption key to the software provision server 600. The application encryption key may alternatively be transferred to the software provision server 600 by means of other information transfer means than network.

Using the application encryption key transmitted in this manner, the application encrypting section 620 of the software provision server 600 encrypts the application. In this instance, the application is composed of a plurality of files. In such cases, it is not necessary to encrypt all files, and only those files which are indispensable to execution of the application (e.g., executable files which are specified at the start of processing functions) may be encrypted.

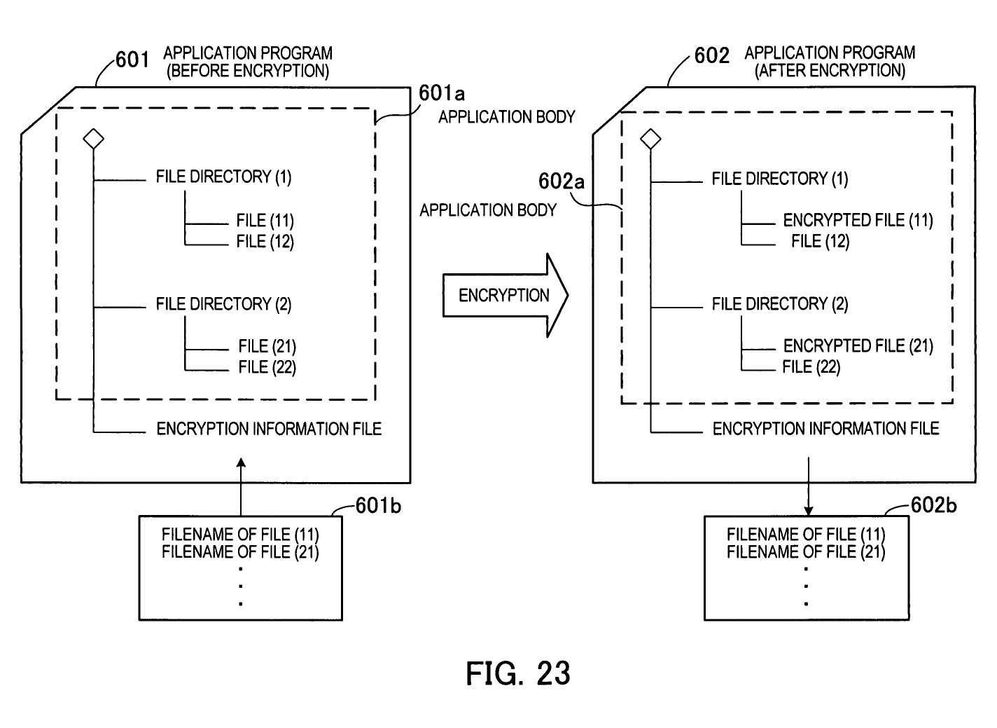

FIG. 23 shows states of the application before and after encryption. The application program 601 before encryption comprises an application body 601a and an encryption information file 601b.

The application body 601a is composed of a plurality of files classified under hierarchical directories. In the example shown in FIG. 23, the identification numbers of directories and files are enclosed with parentheses.

The encryption information file 601b is a list of files which are to be encrypted among those included in the application body 601a, and has set therein the filenames and identification information of the files to be encrypted. In the example of FIG. 23, the files with the identification numbers “11”, “21”, . . . are specified as targets of encryption.

The application program 601 is subjected to encryption, and as a result, only those files which are specified as the encryption target files in the encryption information file 601b are encrypted.

The application program 602 after the encryption comprises an application body 602a and an encryption information file 602b. Among the files included in the application body 602a, only the files listed in the encryption information file 602b have been encrypted. In the following, the file which has been subjected to encryption is called encrypted file.

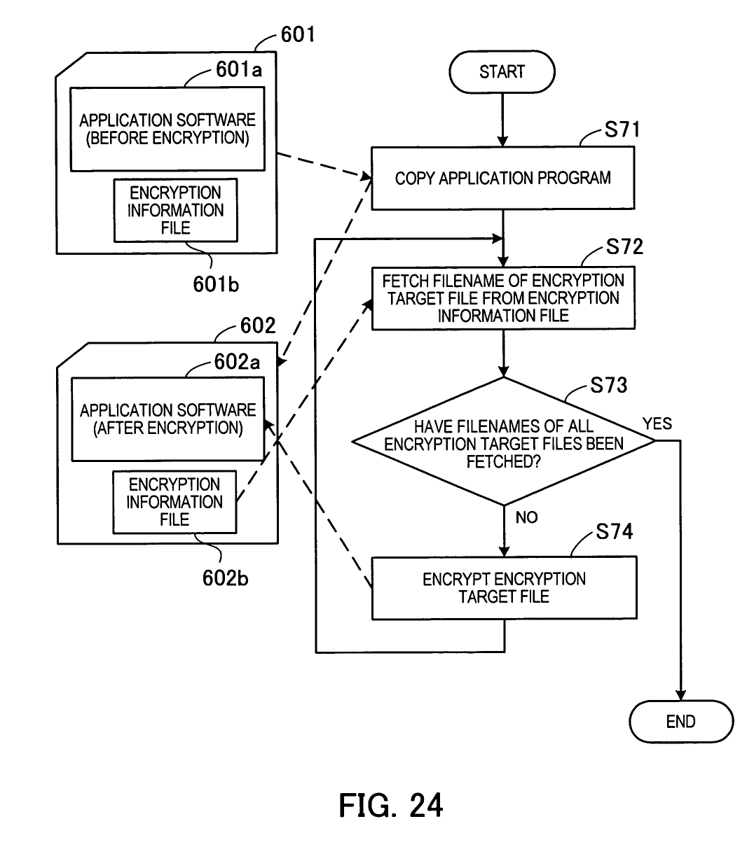

FIG. 24 is a flowchart illustrating the application encryption process. In the following, the process shown in FIG. 24 will be described in order of step number.

[Step S71] The application encrypting section 620 makes a copy of the application program 602.

[Step S72] The application encrypting section 620 fetches the filename of an encryption target file which is not yet encrypted, from the encryption information file 602b in the copy of the application program 602.

[Step S73] The application encrypting section 620 determines whether or not a filename was fetched in Step S72. Namely, if no filename was fetched, it means that the filenames of all encryption target files have been fetched. If the filenames of all encryption target files have been fetched, the application encryption process is ended; if the filename of an encryption target file has been fetched, the process proceeds to Step S74.

[Step S74] The application encrypting section 620 encrypts the corresponding encryption target file in the copy of the application program 602, whereupon the process proceeds to Step S72.

In this manner, only the prespecified files in the application program can be encrypted, whereby the encryption process as well as the decryption process can be speeded up.

The license provision process will be now described.

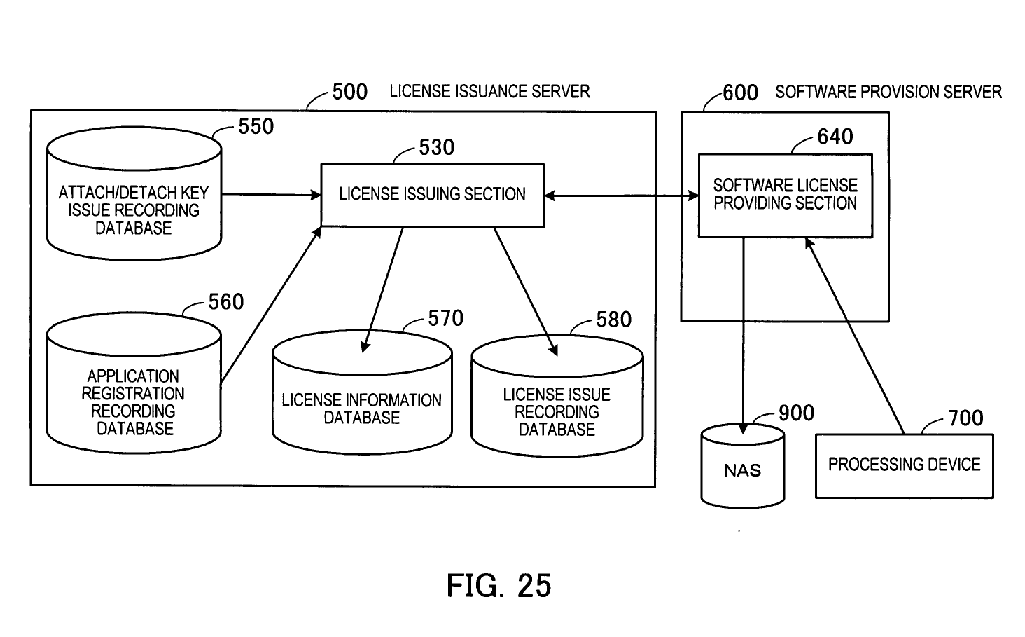

FIG. 25 is a conceptual diagram illustrating the license provision process. First, a license acquisition request is transmitted from the processing device 700 to the software provision server 600. The license acquisition request may alternatively be transferred to the software provision server 600 by means of other information transfer means than network.

On receiving the license acquisition request, the software license providing section 640 in the software provision server 600 transmits an application execution license request to the license issuance server 500. The application execution license request includes the application ID of the application for which a license is to be issued, the license count, the attach/detach key ID of the hardware key attached to the processing device which is a target of operation, etc. The application execution license request may alternatively be transferred to the license issuance server 500 by means of other information transfer means than network.

In the license issuance server 500, the license issuing section 530 receives the application execution license request. Thereupon, the license issuing section 530 looks up the application registration recording database 560 and acquires the application information corresponding to the application ID included in the application execution license request.

Also, the license issuing section 530 looks up the attach/detach key issue recording database 550 and acquires the attach/detach key-specific encryption key in the attach/detach key information corresponding to the chassis ID of the operation target processing device. Then, the license issuing section 530 encrypts the application decryption key in the acquired application information by using the attach/detach key-specific encryption key.

Subsequently, an application execution license including the encrypted application decryption key is generated and registered in the license information database 570. The license issuing section 530 then encrypts the application execution license by using the acquired attach/detach key-specific encryption key.

Subsequently, the license issuing section 530 stores information about the details of license issuance in the license issue recording database 580, and also transmits the encrypted application execution license to the software provision server 600.

In the software provision server 600, the software license providing section 640 receives the application execution license and forwards the received license to the NAS 900 (or other storage device under the control of the computer).

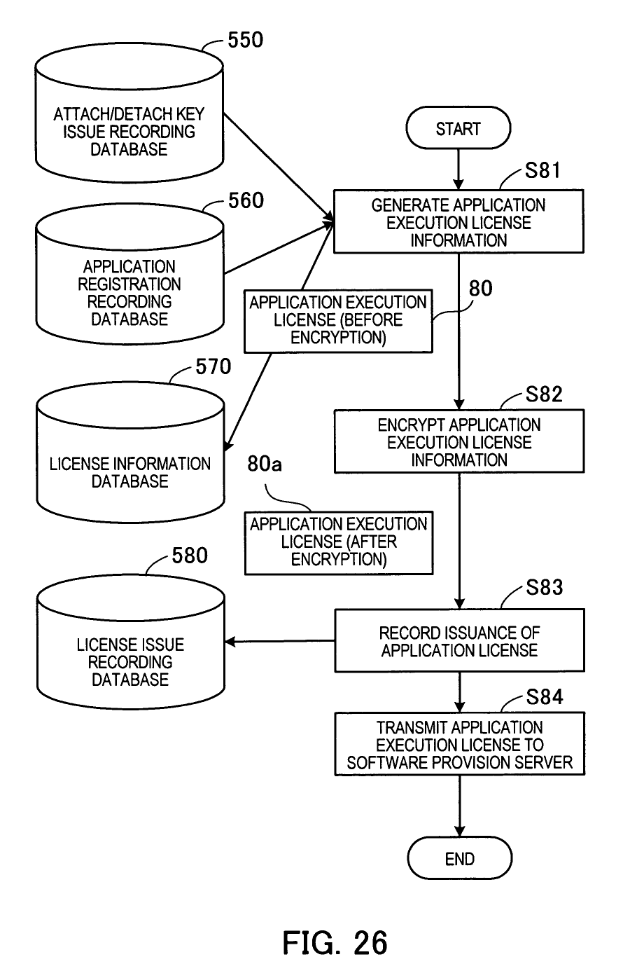

FIG. 26 is a flowchart illustrating the process of the license issuing section. In the following, the process shown in FIG. 26 will be described in order of step number.

[Step S81] On receiving the application execution license request including the application ID, the license count, the attach/detach key ID of the hardware key attached to the operation target processing device, etc., the license issuing section 530 generates an application execution license 80. Specifically, the attach/detach key information corresponding to the attach/detach key ID indicated by the application execution license request is acquired from the attach/detach key issue recording database 550, and the attach/detach key-specific encryption key is extracted from the acquired attach/detach key information.

Subsequently, the license issuing section 530 extracts the application information corresponding to the application ID included in the application execution license request from the application registration recording database 560. Then, the license issuing section 530 encrypts the application decryption key in the extracted application information by using the previously extracted attach/detach key-specific encryption key. Further, the license issuing section 530 generates an application execution license 80 including the chassis ID of the operation target processing device, the application ID, the license count, and the application decryption key encrypted using the attach/detach key-specific encryption key. The generated application execution license 80 is stored in the license information database 570.

[Step S82] The license issuing section 530 encrypts the generated application execution license. In this instance, the attach/detach key-specific encryption key is used for the encryption, and as a result, an encrypted application execution license 80a is generated. Alternatively, public key encryption techniques may be used to generate a pair of keys (secret and public keys) so that the application execution license may be encrypted using the generated secret key.

[Step S83] The license issuing section 530 stores a record on the issue of the application license in the license issue recording database 580. The application license issue record includes the license issue date and time, the application ID, the license count, etc.

[Step S84] The license issuing section 530 transmits the encrypted application execution license 80a to the software provision server 600.

In this manner, the license is issued.

The license issue charge billing process will be now described.

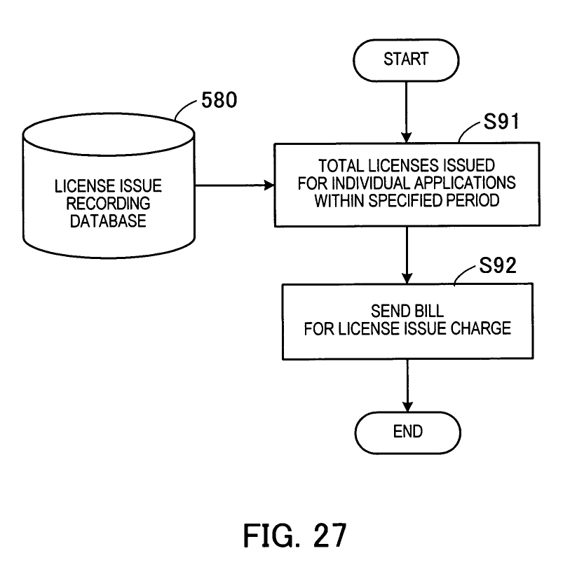

FIG. 27 is a flowchart illustrating the license issue charge billing process. In the following, the process shown in FIG. 27 will be described in order of step number.

[Step S91] The license issue charge billing section 540 looks up the license issue recording database 580 and totals the licenses issued for the individual applications within a predetermined period. Specifically, license issue records showing issuance within a predetermined period (e.g., on a monthly basis) are picked up based on the license issue date and time, and the license issue records are sorted according to the application IDs. Then, for each of the application IDs, a total number of licenses indicated in the license issue records is calculated.

[Step S92] The license issue charge billing section 540 sends the software provider 26 a bill for a license issue charge corresponding to the number of licenses issued.

The application execution process performed in the processing device will be now described.

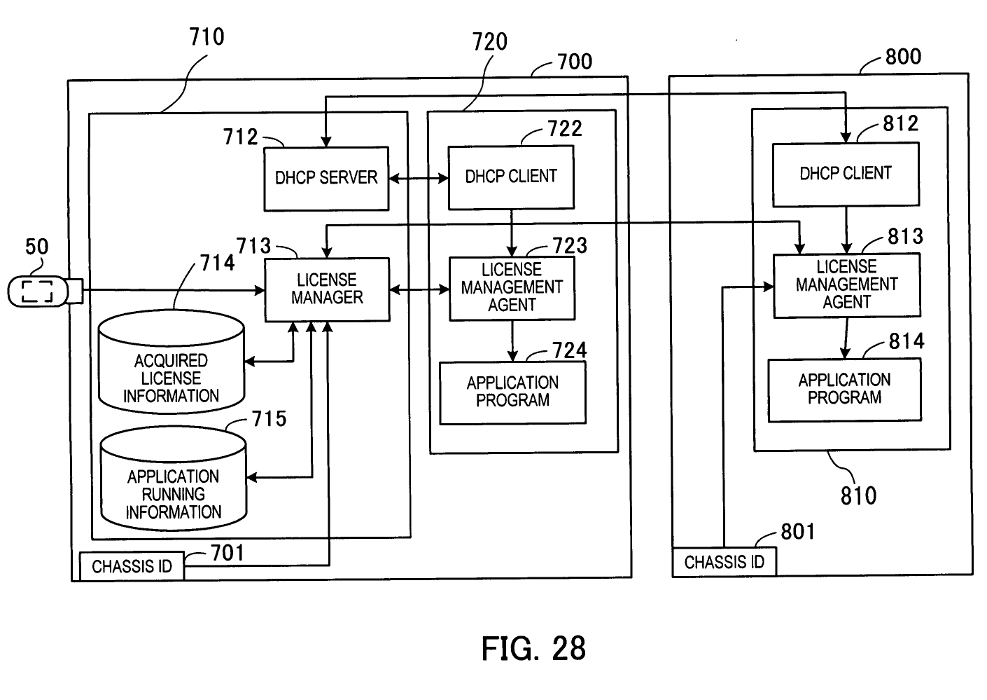

FIG. 28 is a block diagram illustrating processing functions configured in the processing device. A plurality of processing devices, in the illustrated example, two processing devices 700 and 800 are connected to each other by a network. The processing device 700 is connected with the management cartridge 710 and the application cartridge 720, and the processing device 800 is connected with the application cartridge 810. Thus, the management cartridge 710 to be provided may be one in number within the system administered by the user 27. In FIG. 28, the OS functions, among the functions included in the individual cartridges, are omitted.

The management cartridge 710 includes the DHCP server 712, the license manager 713, acquired license information 714, and application running information 715.

The DHCP server 712 allocates IP (Internet Protocol) addresses to the respective application cartridges connected to the network administered by the user 27. Specifically, IP addresses for application cartridges are prepared beforehand, and information on an unused IP address is transmitted in response to an address acquisition request from an application cartridge.

The license manager 713 manages the licenses of application programs executed by the application cartridges 720 and 810. Specifically, on acquiring an application execution license, the license manager analyzes the contents of the license and stores the license information as the acquired license information 714. At this time, the license manager looks up the hardware key 50 and the chassis ID 701 to confirm that the processing device 700 has been set as the operation target in the application execution license.

Also, on receiving an application license confirmation request from an application cartridge, the license manager 713 looks up the acquired license information 714 and the application running information 715 to determine whether the application may be executed or not. The result of determination is sent to the application cartridge.

Further, the license manager 713 monitors the status of running of applications and stores the monitored status as the application running information 715.

The acquired license information 714 comprises a database holding the contents of acquired application execution licenses. The application running information 715 comprises data tables in which are set the statuses of execution of applications in the respective application cartridges.

The acquired license information 714 may be stored in a device accessible from the processing device 700, for example, in the NAS 900. FIG. 28 shows an exemplary case where the acquired license information is stored in the management cartridge 710.

The application cartridge 720 has the DHCP client 722, the license management agent 723, and the application 724. The functions of the application cartridge 720 are configured when the various programs recorded on the memory card 60 are read in the application cartridge 720.

The DHCP client 722 transmits a DHCP-based IP address acquisition request as soon as the OS is started. In response to the IP address acquisition request, the DHCP server 712 sends back information on an IP address, whereupon the DHCP client 722 sets the received IP address as the IP address of the application cartridge. Also, the DHCP client 722 looks up the source address of the packet used for the notification of the IP address information, to identify the IP address of the management cartridge 710 having the DHCP server 712. The DHCP client 722 then notifies the license management agent 723 of the IP address of the management cartridge 710, whereby the license management agent 723 is informed of the location of the license manager 713.

The license management agent 723 inquires of the license manager 713 whether the application program 602 stored in the memory card 60 may be executed or not, and if execution is permitted, decrypts the application program 602. The license management agent 723 restores the non-encrypted application program 601 by decrypting the application program 602, whereupon the functions of the application 724 become available.

The application 724 is the processing function accomplished by the application program 602 stored in the memory card 60.

The application cartridge 810 connected to the processing device 800 has a DHCP client 812, a license management agent 813, and an application 814. The functions of the application cartridge 810 are configured when the various programs recorded on the memory card 70 are read in the application cartridge 810.

The application cartridge 810 is connected to the slot #0 of the processing device 800. Since only the processor cartridge connected to the slot #0 is allowed to read the chassis ID 801 of the processing device 800, the application cartridge 810 can read the chassis ID 801. In the case where the application cartridge 810 is connected to a different slot, the chassis ID 801 can be acquired through the processor cartridge connected to the slot #0. Where wiring is laid out so that all slots can access the identification information memory storing the chassis ID 801, the application cartridges connected to the other slots than the slot #0 also can directly read the chassis ID 801.

The function of the DHCP client 812 is the same as that of the DHCP client 722 of the application cartridge 720. Also, the function of the license management agent 813 is identical with that of the license management agent 723 of the application cartridge 720, and the function of the application 814 is identical with that of the application 724 of the application cartridge 720.

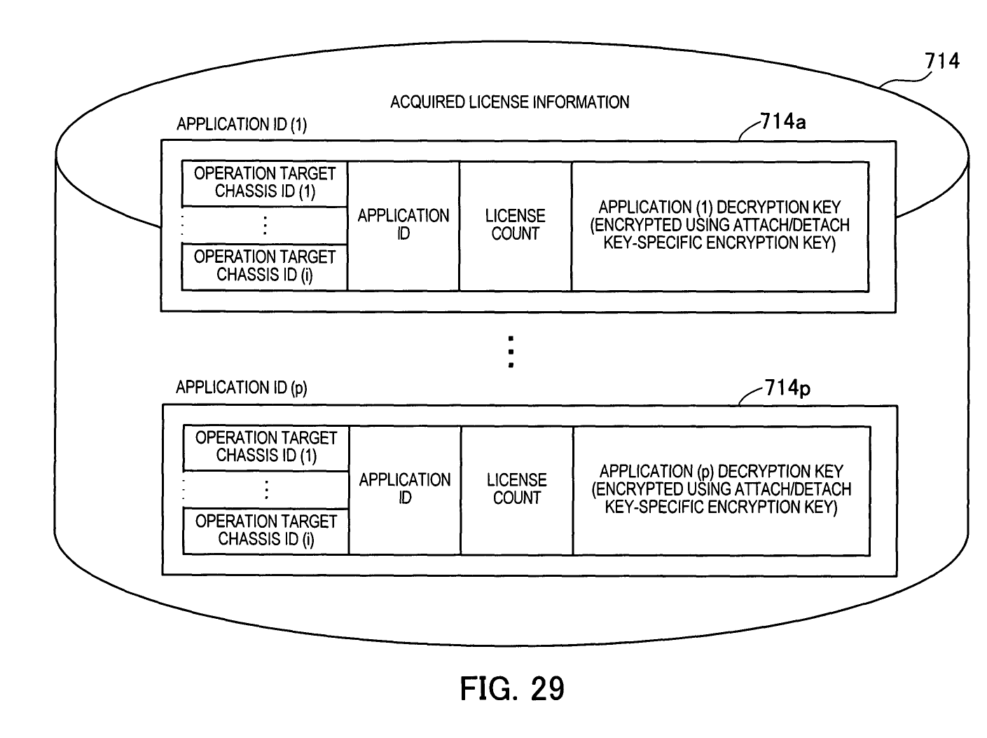

FIG. 29 shows an exemplary data structure of the acquired license information. The acquired license information 714 holds a plurality of application execution licenses 714a, . . . , 714p. The data structure of the application execution licenses 714a, . . . , 714p is identical with that of the application execution license 80 shown in FIG. 16. The application execution licenses 714a, . . . , 714p stored as the acquired license information 714 are each decrypted (plaintext) data except for the application decryption key. To prevent falsification, however, the application execution licenses 714a, . . . , 714p may be encrypted in their entirety to be stored as the acquired license information 714. In this case, the application execution licenses 714a, . . . , 714p are decrypted each time it is read from the acquired license information 714.

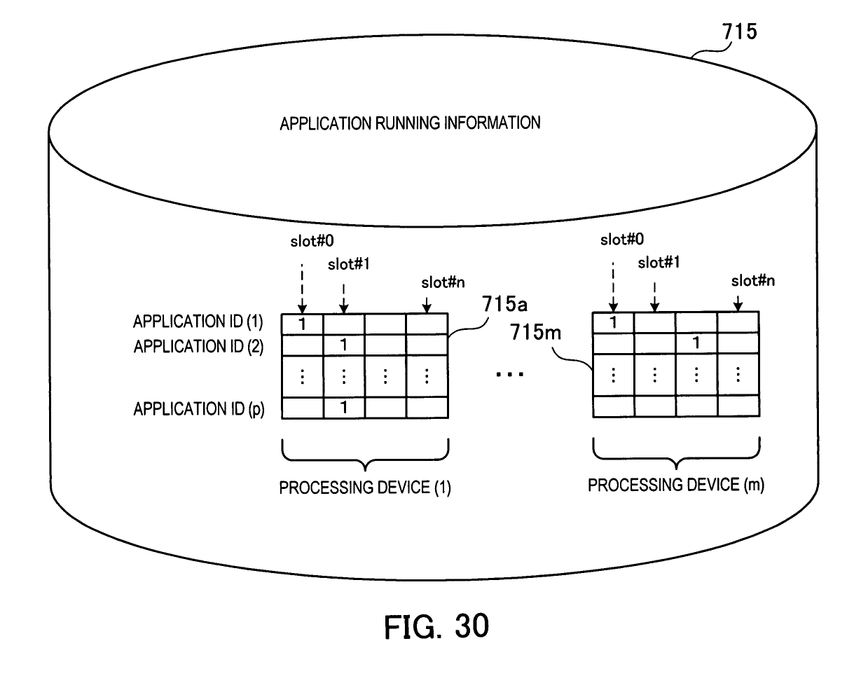

FIG. 30 shows an exemplary data structure of the application running information. The application running information 715 has application running tables 715a, 715m associated with the respective processing devices. Each of the application running tables 715a, . . . , 715m indicates which application cartridge connected to which slot of the corresponding processing device is executing what application or applications.

Specifically, the application running tables 715a, . . . , 715m are each a table of matrix form, with the application IDs allocated along the column and the slot numbers along the row. If “1” is set in a cell specifiable by the application ID and the slot number, it means that the application with the corresponding application ID is being executed in the application cartridge connected to the corresponding slot number.

The processing devices 700 and 800 configured as described above make it possible to execute duly licensed applications.

The following describes how an application is started by the license management agent 723.

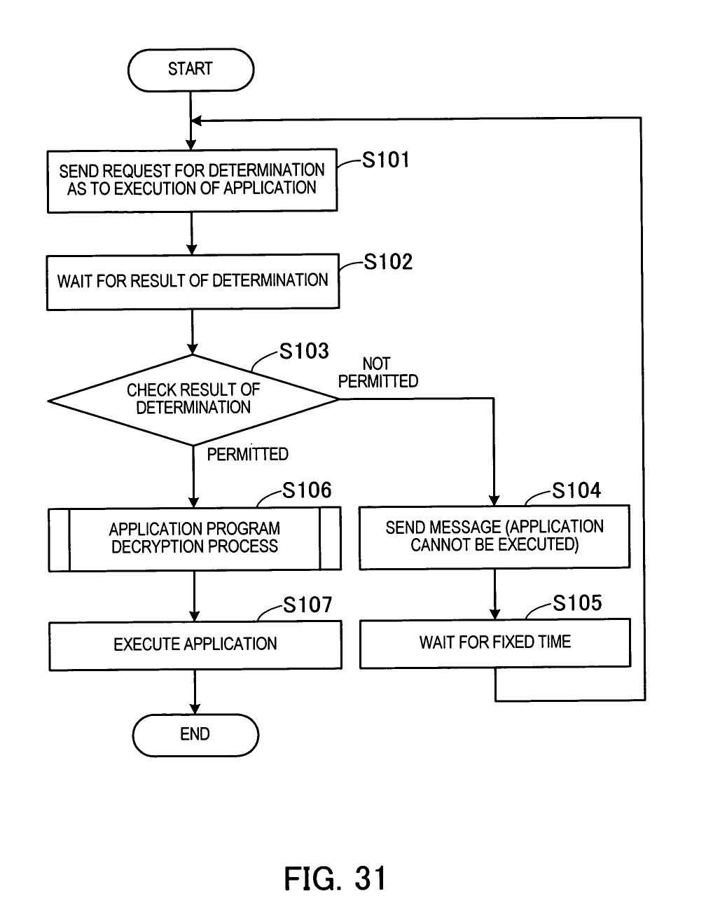

FIG. 31 is a flowchart showing the application starting process. This process is started when an application start request is output. The application start request may be automatically output from the OS at the start of the OS. Alternatively, the application start request may be output in response to an input operation by the user 27. In the following, the process shown in FIG. 31 will be described in order of step number.

[Step S101] The license management agent 723 sends a request for determination as to execution of an application (license confirmation request) to the license manager 713. The license confirmation request includes the application ID and the chassis ID. If the application cartridge making the request is the one connected to the slot #0 of the processing device, the application cartridge can directly read the chassis ID and affix the read ID to the license confirmation request. An application cartridge connected to a different slot can acquire the chassis ID by sending an inquiry to the processor cartridge (management cartridge or application cartridge) connected to the slot #0. Where the identification information memory storing the chassis ID is connected to all slots, all application cartridges can directly read the chassis ID.

[Step S102] The license management agent 723 waits for the result of determination as to execution of the application from the license manager 713. When the result of determination is received, the process proceeds to Step S103. In the case where execution of the application is permitted, the result of determination includes the application decryption key.

[Step S103] The license management agent 723 checks the contents of the response from the license manager 713. If execution of the application is permitted, the process proceeds to Step S106; if execution of the application is not permitted, the process proceeds to Step S104.

[Step S104] The license management agent 723 sends a message to the process from which the application start request has been outputted to the effect that the application cannot be executed.

[Step S105] The license management agent 723 waits for a fixed time, and then the process proceeds to Step S101.

[Step S106] When execution of the application is permitted, the license management agent 723 performs an application program decryption process, described in detail later.

[Step S107] The license management agent 723 outputs a request for execution of the executable file of the decrypted application program, to start the application.

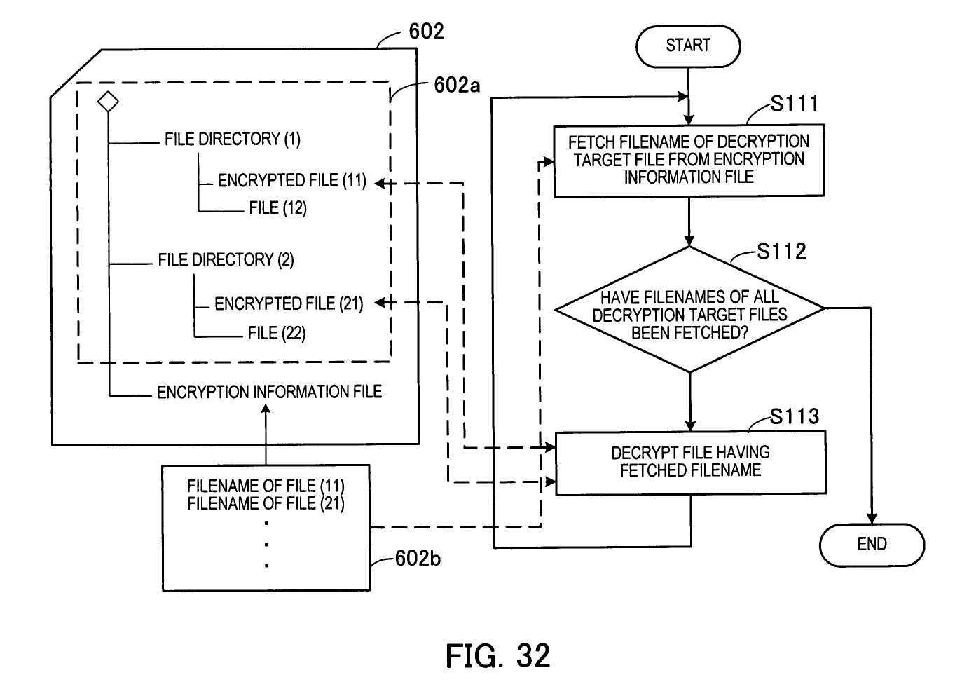

FIG. 32 is a flowchart showing the application program decryption process. In the following, the process shown in FIG. 32 will be described in order of step number.

[Step S111] The license management agent 723 fetches the filename of a non-decrypted target file from the encryption information file 602b.

[Step S112] The license management agent 723 determines whether the filenames of all target files to be decrypted have been fetched or not. Namely, if, in Step S111, no filename was found as a decryption target file, it is judged that the filenames of all decryption target files have been fetched, and accordingly, the process is ended. If a filename was fetched as a decryption target file, the process proceeds to Step S113.

[Step S113] The license management agent 723 fetches the file corresponding to the fetched filename from the application body 602a and decrypts the file. In this case, the file is decrypted using the application decryption key transferred from the license manager 713 together with the execution determination result.

After the decryption of the file is completed, the process proceeds to Step S111.

In this manner, the application is started using the application program decrypted by the license management agent. In this case, since the license manager 713 has already output permission to execute the application, it recognizes that the application 724 is being executed by the application cartridge 720.

When execution of the application is terminated, this needs to be notified to the license manager 713. The process for notifying such an application running status is also carried out by the license management agent 723.

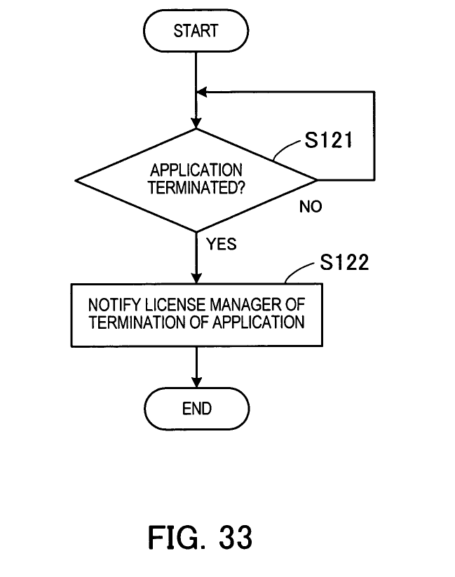

FIG. 33 is a flowchart showing the process performed at the termination of an application. In the following, the process shown in FIG. 33 will be described in order of step number.

[Step S121] The license management agent 723 determines whether or not the application has terminated. If the application has terminated, the process proceeds to Step S122. On the other hand, if the application has not yet terminated, Step S121 is repeated, whereby the application running status is monitored by the license management agent 723.

[Step S122] The license management agent 723 notifies the license manager 713 that the application has terminated.

In this manner, when the application has terminated, the license manager 713 is notified of the termination of the application.

Also, in the second embodiment, it is periodically determined whether or not the application may be continuously executed, and only when continued execution is permitted, the application can be continuously executed.

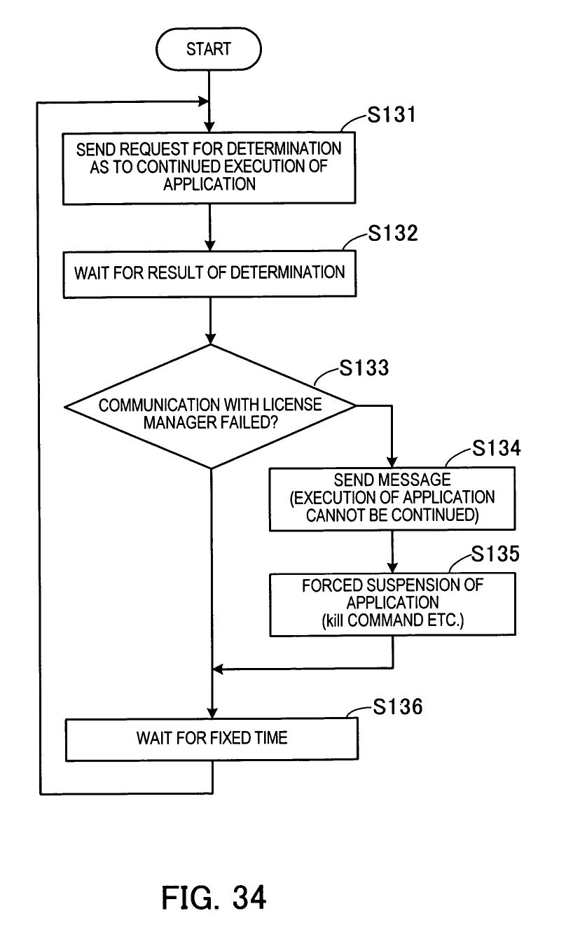

FIG. 34 is a flowchart showing the continued application execution monitoring process. In the following, the process shown in FIG. 34 will be described in order of step number.

[Step S131] The license management agent 723 transmits a request for determination as to continued execution of the application to the license manager 713. The continued execution determination request includes the application ID and the chassis ID.

[Step S132] The license management agent 723 waits for the result of determination as to continued execution. On receiving the result of determination, the process proceeds to Step S133. Also when communication with the license manager 713 is found to have failed, the process proceeds to Step S133.

[Step S133] The license management agent 723 determines whether or not continued execution of the application is permitted. If the result of continued execution determination indicates that the application may be continuously executed, it is judged that continued execution of the application is permitted. If the result of continued execution determination indicates that the application cannot be continuously executed, or if the communication with the license manager 713 failed, it is judged that continued execution of the application is not permitted. If continued execution is permitted, the process proceeds to Step S136; if continued execution is not permitted, the process proceeds to Step S134.

[Step S134] The license management agent 723 sends a message to the process which is executing the application to the effect that the application cannot be continuously executed.

[Step S135] The license management agent 723 forcedly suspends the process executing the application. The process then proceeds to Step S136.

[Step S136] The license management agent 723 waits for a fixed time. Upon lapse of the fixed time, the process proceeds to Step S131.

The aforementioned process is repeatedly executed until the application termination process is performed.

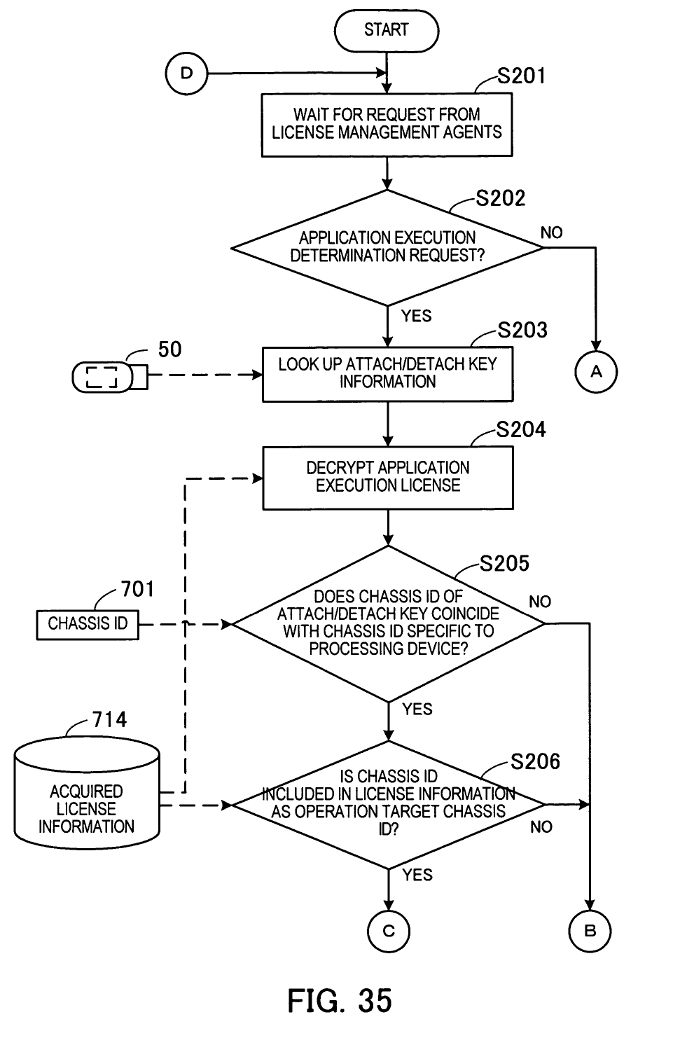

Referring now to FIGS. 35 to 38, the process executed by the license manager 713 will be described in detail.

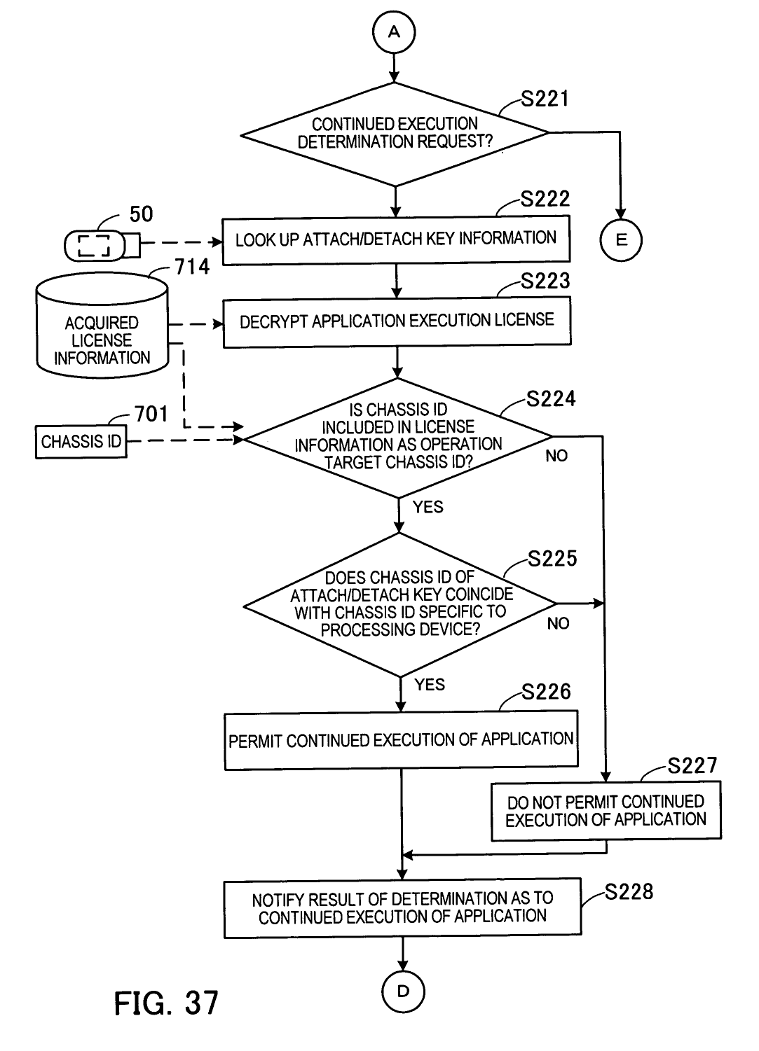

FIG. 35 is a first flowchart showing the process of the license manager. In the following, the process shown in FIG. 35 will be described in order of step number.

[Step S201] The license manager 713 waits for a request from the license management agents. If a request is received from any of the license management agents, the process proceeds to Step S202. Such a request from a license management agent includes the application ID and the chassis ID.

[Step S202] The license manager 713 determines whether or not the request received from the license management agent is a request for determination as to execution of the application. If the received request is an application execution determination request, the process proceeds to Step S203; if not, the process proceeds to Step S221 in FIG. 37.

[Step S203] The license manager 713 looks up the attach/detach key information stored in the hardware key 50.

[Step S204] The license manager 713 decrypts the application execution license by using a decryption algorithm corresponding to the algorithm by means of which the application execution license has been encrypted. Specifically, the license manager 713 acquires, from the acquired license information 714, the application execution license corresponding to the application ID included in the application execution determination request. Then, using the attach/detach key-specific encryption key in the attach/detach key information stored in the hardware key 50, the license manager decrypts the application execution license.

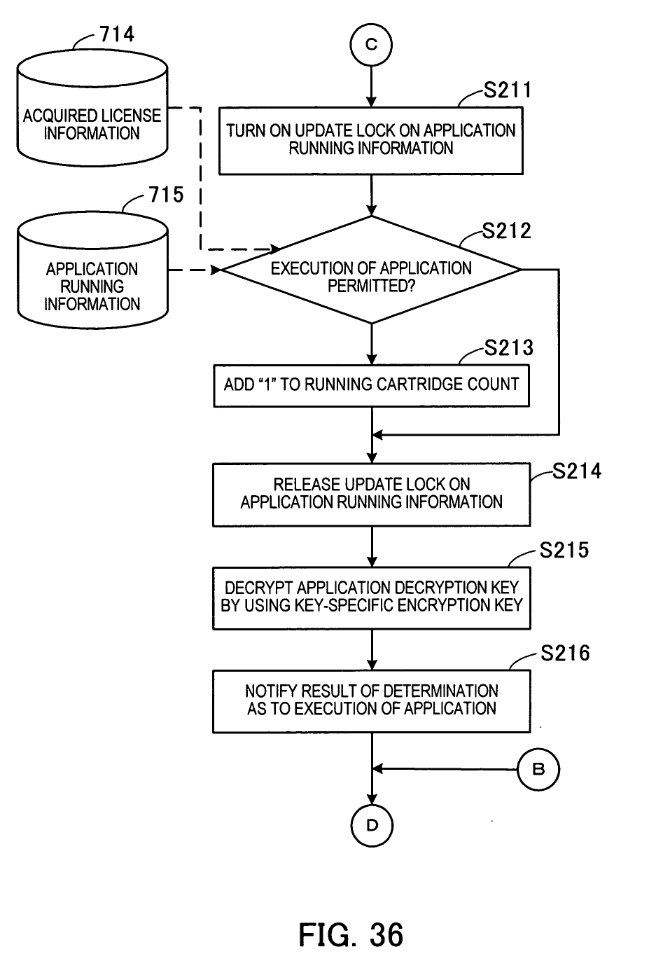

In the case where the application execution license has been encrypted using a secret key which was generated along with a public key by using public key encryption techniques, the application execution license is decrypted using the public key generated simultaneously with the secret key.

[Step S205] The license manager 713 determines whether or not the chassis ID of the attach/detach key information coincides with the chassis ID 701 specific to the processing device 700. If the chassis IDs coincide, the process proceeds to Step S206; if not, the process proceeds to Step S216 in FIG. 36.

[Step S206] The license manager 713 determines whether or not the chassis ID is set as an operation target chassis ID in the application execution license decrypted in Step S204. If the chassis ID is set as an operation target chassis ID, the process proceeds to Step S211 in FIG. 36; if not, the process proceeds to Step S216 in FIG. 36.

FIG. 36 is a second flowchart showing the process of the license manager. In the following, the process shown in FIG. 36 will be described in order of step number.

[Step S211] The license manager 713 turns on an update lock on the application running information 715.

[Step S212] The license manager 713 looks up the acquired license information 714 and the application running information 715 to determine whether or not the application may be executed. Specifically, the license manager 713 looks up the application running information 715 to count the number of application cartridges (running cartridge count) executing the application with respect to which the determination is being made. Then, the license manager 713 compares the running cartridge count with the license count in the application execution license decrypted in Step S204. If the license count is larger than the running cartridge count, it is judged that the application may be executed; if not, it is judged that the application should not be executed.

If it is judged that the application may be executed, the process proceeds to Step S213; if it is judged that the application should not be executed, the process proceeds to Step S214.

[Step S213] The license manager 713 adds “1” to the running cartridge count.

[Step S214] The license manager 713 releases the update lock on the application running information 715.

[Step S215] The license manager 713 decrypts the application decryption key included in the application execution license by using the attach/detach key-specific encryption key.

[Step S216] The license manager 713 sends a notification of the result of determination as to execution of the application to the license management agent from which the determination has been requested. The result of determination includes the application decryption key decrypted in Step S215. Subsequently, the process proceeds to Step S201 in FIG. 35.

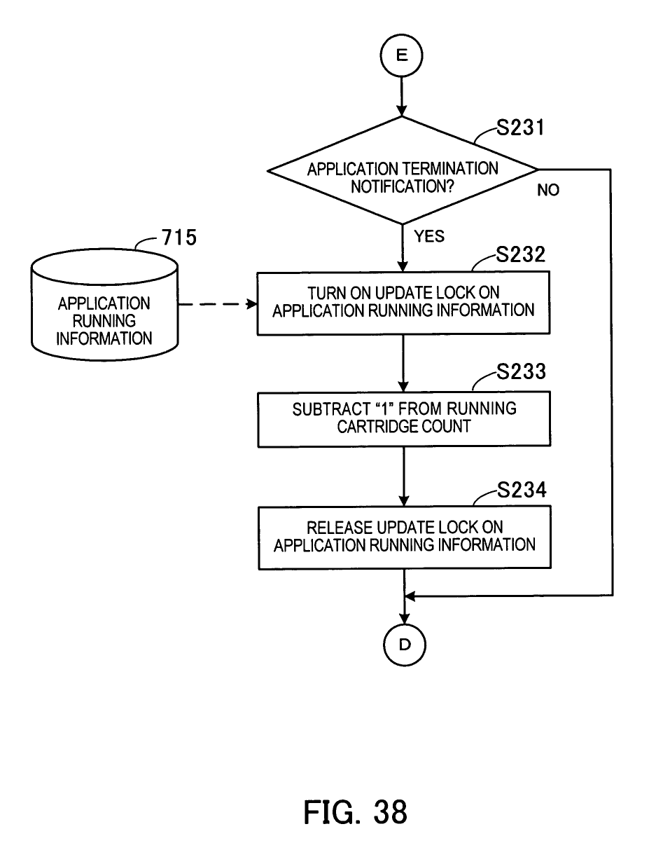

FIG. 37 is a third flowchart showing the process of the license manager. In the following, the process shown in FIG. 37 will be described in order of step number.

[Step S221] The license manager 713 determines whether or not the received request is a request for determination as to continued execution of the application. The continued execution determination request includes the application ID and the chassis ID. If the received request is a continued execution determination request, the process proceeds to Step S222; if not, the process proceeds to Step S231 in FIG. 38.

[Step S222] The license manager 713 looks up the attach/detach key information stored in the hardware key 50.

[Step S223] The license manager 713 decrypts the application execution license by using the decryption algorithm corresponding to the algorithm by means of which the application execution license has been encrypted. Specifically, the license manager 713 acquires, from the acquired license information 714, the application execution license corresponding to the application ID included in the continued execution determination request. Then, using the attach/detach key-specific encryption key in the attach/detach key information stored in the hardware key 50, the license manager decrypts the application execution license.

In the case where the application execution license has been encrypted using a secret key which was generated along with a public key by using public key encryption techniques, the application execution license is decrypted using the public key generated simultaneously with the secret key.

[Step S224] The license manager 713 determines whether or not the chassis ID is set as an operation target chassis ID in the application execution license decrypted in Step S223. If the chassis ID is set as an operation target chassis ID, the process proceeds to Step S225; if not, the process proceeds to Step S227.

[Step S225] The license manager 713 determines whether or not the chassis ID of the attach/detach key information coincides with the chassis ID 701 specific to the processing device 700. If the chassis IDs coincide, the process proceeds to Step S226; if not, the process proceeds to Step S227.

[Step S226] The license manager 713 judges that the application may be continuously executed, whereupon the process proceeds to Step S228.

[Step S227] The license manager 713 judges that the application should not be continuously executed.

[Step S228] The license manager 713 sends a notification of the result of determination as to continued execution of the application to the application management agent from which the determination has been requested. The process then proceeds to Step S201.

FIG. 38 is a fourth flowchart showing the process of the license manager. In the following, the process shown in FIG. 38 will be described in order of step number.

[Step S231] The license manager 713 determines whether or not the request from the license management agent is a notification of termination of the application. If an application termination notification has been received, the process proceeds to Step S232; otherwise the process proceeds to Step S201 in FIG. 35.

[Step S232] The license manager 713 turns on an update lock on the application running information 715.

[Step S233] The license manager 713 subtracts “1” from the running cartridge count corresponding to the terminated application.

[Step S234] The license manager 713 releases the update lock on the application running information. The process then proceeds to Step S201 in FIG. 35.

Thus, it is possible to carry out license management whereby illegal use of applications can be securely prevented. Specifically, the hardware key having device identification information (chassis ID) embedded therein is provided, and the application cannot be executed unless the device identification information set in the hardware key coincides with the device identification information of a processing device which is to execute the application. Consequently, illegal acts such as camouflage of processing devices can be prevented.

The hardware key is issued by the license issuance authority, and therefore, licenses can be strictly managed. In order to give priority to convenience etc., however, the hardware key may be issued by the software provider.

Moreover, each application cartridge automatically sends a license confirmation request to the management cartridge as soon as it is mounted to the chassis of the processing device, and permission to execute the application is given only to application cartridges not exceeding the license count. It is therefore unnecessary to set license information in the individual application cartridges, making it easy for the user 27 to administer the system.

Also, the management cartridge always has an accurate grasp of the number of application cartridges currently executing the application. When an application cartridge executing the application is detached for maintenance, for example, permission to execute the application is automatically given to another application cartridge which is allowed to execute the application. Accordingly, it is possible to prevent the processing efficiency of the overall system from lowering at the time of maintenance of the processing device.

In the second embodiment, the license issuance server 500 and the software provision server 600 are assigned respective different functions, but a single server (e.g., software provision server) may take care of writing the attach/detach key information in the hardware key, providing software and issuing license.

Also, in the first and second embodiments, the device identification information (chassis ID) is recorded in memory, and such memory may be any circuit fixed to the device and capable of holding data. For example, CPU identification information set within the CPU may be used as the device identification information.

In the first embodiment, two keys, that is, a software encryption key and a software decryption key, are generated, but a single key may be used as both the software encryption and decryption keys. Similarly, in the second embodiment, two keys, that is, an application encryption key and an application decryption key, are generated, but a single key may be used as both the application encryption and decryption keys.

The processing functions described above can be performed by a computer. In this case, a program is prepared in which are described processes for performing the functions of the processing device management server, license issuance server, software provision server, and processor cartridge in the processing device. The program is executed by a computer, whereupon the aforementioned processing functions are accomplished by the computer. The program describing the required processes may be recorded on a computer-readable recording medium. The computer-readable recording medium includes a magnetic recording device, an optical disc, a magneto-optical recording medium, a semiconductor memory, etc. The magnetic recording device to be used may be a hard disk drive (HDD), a flexible disk (FD), a magnetic tape or the like. As the optical disc, a DVD (Digital Versatile Disc), a DVD-RAM (Random Access Memory), a CD-ROM (Compact Disc Read Only Memory), a CD-R (Recordable)/RW (ReWritable) or the like may be used. The magneto-optical recording medium includes an MO (Magneto-Optical disc) etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer loads the program from its storage device and performs processes in accordance with the program. The computer may load the program directly from the portable recording medium to perform processes in accordance with the program. Also, as the program is transferred from the server computer, the computer may sequentially perform processes in accordance with the program.

As described above, according to the first and second aspects of the present invention, the software decryption key is encrypted using the device identification information, and accordingly, the encrypted software can be decrypted only in the processing device in which the device identification information is fixedly recorded. Accordingly, even if the software is stored in a different device, it cannot be executed by that device, whereby illegal use of the software can be prevented.

According to the third and fourth aspects of the present invention, only the processing device to which a correct hardware key is attached can decrypt the license information as well as the encrypted software. Moreover, since the device identification information is stored in the hardware key, the software can be decrypted only by the processing device whose device identification information coincides with that stored in the hardware key.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A license issuance server for issuing a license for execution of software, comprising:
software encryption key generating means, responsive to an encryption key generation request for the software, for generating a software encryption key and a software decryption key for decrypting the software encrypted using the software encryption key; and
license issuing means, responsive to a license issue request including device identification information fixedly recorded on a recording medium in a processing device which is a target of permission to run the software, for encrypting the software decryption key by using the device identification information and outputting a software license including the encrypted software decryption key.

2. The license issuance server according to claim 1, wherein, if the encryption key generation request is received from a different computer connected via a network, said software encryption key generating means transmits the generated software encryption key to said different computer.

3. The license issuance server according to claim 1, wherein, if the license issue request is received from a different computer connected via a network, said license issuing means transmits the generated software license to said different computer.

4. A software provision server for providing software whose execution is to be restricted by a license, comprising:
software encryption key generating means, responsive to an encryption key generation request for the software, for generating a software encryption key and a software decryption key for decrypting the software encrypted using the software encryption key;
software encrypting means for encrypting the software by using the software encryption key generated by said software encryption key generating means;
software providing means, responsive to input of a software request which is received from a processing device as a target of permission to run the software and which includes device identification information fixedly recorded on a recording medium in the processing device, for transmitting the software encrypted by said software encrypting means to the processing device; and
license issuing means, responsive to input of the software request from the processing device, for encrypting the software decryption key by using the device identification information and outputting a software license including the encrypted software decryption key to the processing device.

5. A processing device for executing software whose execution is restricted by a license, comprising:
a recording medium on which device identification information is fixedly recorded;
decryption key decrypting means, responsive to reception of a software decryption key which has been encrypted, for decrypting the software decryption key by using the device identification information recorded on said recording medium as a decryption key; and
software decrypting means, responsive to reception from a software provision server of the software which has been encrypted, for decrypting the software by using the software decryption key decrypted by said decryption key decrypting means as a decryption key.

6. A license issuance server for issuing a license for execution of software, comprising:
attach/detach key information issuing means, responsive to an attach/detach key information generation request including device identification information fixedly recorded on a recording medium in a processing device which is a target of permission to run the software, for generating attach/detach key information including the device identification information and an attach/detach key-specific encryption key, and recording the generated attach/detach key information on a hardware key which can be attached to and detached from the processing device; and
license issuing means, responsive to a license issue request for the software, for encrypting a software decryption key for decrypting the software which is provided in an encrypted state, by using the attach/detach key-specific encryption key, and outputting license information including the encrypted software decryption key.

7. The license issuance server according to claim 6, wherein said license issuing means includes, in the license information, a license count indicating a number of devices permitted to simultaneously execute the software.

8. The license issuance server according to claim 6, wherein said hardware key has tamper resistance.

9. The license issuance server according to claim 6, wherein said license issuing means encrypts the license information before outputting same.

10. The license issuance server according to claim 9, wherein said license issuing means encrypts the license information by using the attach/detach key-specific encryption key.

11. The license issuance server according to claim 6, further comprising license issue charge calculating means for storing past records on the license information output from said license issuing means, and calculating, based on the stored license information, a license issue charge to be billed to a provider of the software.

12. A software provision server for providing software whose execution is to be restricted by a license, comprising:
attach/detach key information issuing means, responsive to an attach/detach key information generation request including device identification information fixedly recorded on a recording medium in a processing device which is a target of permission to run the software, for generating attach/detach key information including the device identification information and an attach/detach key-specific encryption key, and recording the generated attach/detach key information on a hardware key which can be attached to and detached from the processing device;
software encryption key generating means for generating a software encryption key for encrypting and decrypting the software, and a software decryption key for decrypting data encrypted by using the software encryption key;
software encrypting means for encrypting the software by using the software encryption key generated by said software encryption key generating means;
software providing means, responsive to input of a software request from the processing device, for transmitting the software encrypted by said software encrypting means to the processing device; and
license issuing means, responsive to a license issue request for the software, for encrypting the software decryption key by using the attach/detach key-specific encryption key, and outputting license information including the encrypted software decryption key.

13. A processing device for executing software whose execution is restricted by a license, comprising:
a recording medium on which device identification information is fixedly recorded;
hardware key connecting means for reading attach/detach key information including an attach/detach key-specific encryption key and permission target device identification information specifying a device which is a target of permission to run the software, from a hardware key storing the attach/detach key information when the hardware key is attached;
software key decrypting means, responsive to input of license information including an encrypted software decryption key for decrypting the software which has been encrypted, for decrypting the software decryption key by using the attach/detach key-specific encryption key;
identification information determining means for determining sameness of the permission target device identification information included in the hardware key attached to said hardware key connecting means with the device identification information recorded on said recording medium; and
software decrypting means for decrypting the encrypted software by using the software decryption key decrypted by said software key decrypting means if the sameness is confirmed by said identification information determining means.

14. A software execution management device for managing status of execution of software whose execution is restricted by a license, comprising:
a recording medium on which device identification information is fixedly recorded;
hardware key connecting means for reading attach/detach key information including an attach/detach key-specific encryption key and permission target device identification information specifying a device which is a target of permission to run the software, from a hardware key storing the attach/detach key information when the hardware key is attached;
software key decrypting means, responsive to input of license information including an encrypted software decryption key for decrypting the software which has been encrypted and a number of computers permitted to execute the software simultaneously, for decrypting the software decryption key by using the attach/detach key-specific encryption key; and
decryption key managing means for monitoring computers connected via a network to detect a number of computers executing the software, and transferring the software decryption key decrypted by said software key decrypting means to a number of computers equal to or smaller than the number of computers permitted to execute the software simultaneously.

15. A license issuing method for issuing a license for execution of software, comprising the steps of:
generating, in response to an encryption key generation request for the software, a software encryption key and a software decryption key for decrypting the software encrypted by using the software encryption key; and
encrypting, in response to a license issue request including device identification information fixedly recorded on a recording medium in a processing device which is a target of permission to run the software, the software decryption key by using the device identification information, and outputting a software license including the encrypted software decryption key.

16. A license issuing method for issuing a license for execution of software, comprising the steps of:
generating, in response to an attach/detach key information generation request including device identification information fixedly recorded on a recording medium in a processing device which is a target of permission to run the software, attach/detach key information including the device identification information and an attach/detach key-specific encryption key, and recording the generated attach/detach key information on a hardware key which can be attached to and detached from the processing device; and
encrypting, in response to a license issue request for the software, a software decryption key for decrypting the software provided in an encrypted state, by using the attach/detach key-specific encryption key, and outputting license information including the encrypted software decryption key.

17. A license issuing program for issuing a license for execution of software, wherein said license issuing program causes a computer to perform the processes of:
generating, in response to an encryption key generation request for the software, a software encryption key and a software decryption key for decrypting the software encrypted by using the software encryption key; and
encrypting, in response to a license issue request including device identification information fixedly recorded on a recording medium in a processing device which is a target of permission to run the software, the software decryption key by using the device identification information, and outputting a software license including the encrypted software decryption key.

18. A license issuing program for issuing a license for execution of software, wherein said license issuing program causes a computer to perform the processes of:
generating, in response to an attach/detach key information generation request including device identification information fixedly recorded on a recording medium in a processing device which is a target of permission to run the software, attach/detach key information including the device identification information and an attach/detach key-specific encryption key, and recording the generated attach/detach key information on a hardware key which can be attached to and detached from the processing device; and
encrypting, in response to a license issue request for the software, a software decryption key for decrypting the software provided in an encrypted state, by using the attach/detach key-specific encryption key, and outputting license information including the encrypted software decryption key.

19. A computer-readable recording medium recording a license issuing program for issuing a license for execution of software, wherein the license issuing program causes the computer to perform the processes of:
generating, in response to an encryption key generation request for the software, a software encryption key and a software decryption key for decrypting the software encrypted by using the software encryption key; and
encrypting, in response to a license issue request including device identification information fixedly recorded on a recording medium in a processing device which is a target of permission to run the software, the software decryption key by using the device identification information, and outputting a software license including the encrypted software decryption key.

20. A computer-readable recording medium recording a license issuing program for issuing a license for execution of software, wherein the license issuing program causes the computer to perform the processes of:
generating, in response to an attach/detach key information generation request including device identification information fixedly recorded on a recording medium in a processing device which is a target of permission to run the software, attach/detach key information including the device identification information and an attach/detach key-specific encryption key, and recording the generated attach/detach key information on a hardware key which can be attached to and detached from the processing device; and
encrypting, in response to a license issue request for the software, a software decryption key for decrypting the software provided in an encrypted state, by using the attach/detach key-specific encryption key, and outputting license information including the encrypted software decryption key.
